(19) United States
(12) Patent Application Publication
(10) Pub. No.: US 2026/0257383 A1
(43) Pub. Date: Sep. 3, 2026

(54) HUMANOID ROBOT HARNESS SYSTEM

(71) Applicant: Figure AI Inc., San Jose, CA (US)

(72) Inventors: Sydney Hardy, San Jose, CA (US); David McCall, San Jose, CA (US); John Wilkening, San Jose, CA (US); Brian Mick, San Jose, CA (US); Nivay Anandarajah, San Jose, CA (US); Katarina Rodak, San Jose, CA (US)

(21) Appl. No.: 19/655,695

(22) Filed: Apr. 22, 2026

Related U.S. Application Data
(60) Provisional application No. 63/383,918, filed on Nov. 16, 2022.
(60) Provisional application No. 63/792,520, filed on Apr. 22, 2025.

(51) Int. Cl. B25J 19/06; B62D 57/02

(52) U.S. Cl. CPC B25J 19/06; B62D 57/02

(57) ABSTRACT

A humanoid-robot support system includes a humanoid robot having a torso and a waist, with left and right harness supports formed on the waist, together with a removable harness carried on the torso. Each harness support defines a concave anchor recess having an anchor aperture and, in some embodiments, a separate docking aperture sized to receive a docking arm of a support stand. Left and right frame couplers extend from the harness down to the waist, each including a waist coupler having a main body with a strap aperture, a transverse body, and an angular body carrying a projection that is received in the anchor aperture, the coupler bearing against the waist through a compliant high-friction lining. The harness supports are positioned rearward of the robot's coronal plane and on opposite sides of a vertical plane containing the torso's center of gravity, so that suspension load is transferred to the waist while the robot hangs substantially upright.

### CROSS REFERENCE TO RELATED APPLICATIONS

This application is claims the benefit and priority to U.S. Provisional Application Nos. 63/792,520, filed Apr. 22, 2025, and 63/383,918, filed Jul. 7, 2025, each of which is fully incorporated herein by reference.

### TECHNICAL FIELD

This disclosure relates to a harness system for a humanoid robot, specifically a general-purpose humanoid robot. In particular, a harness system that helps prevent the humanoid robot from falling and contacting the ground or another object, and/or helps the humanoid robot carry additional gear or peripherals.

### BACKGROUND

The contemporary industrial and commercial landscape faces significant challenges related to labor availability, particularly for tasks deemed unsafe or undesirable. Within the United States alone, estimates suggest over 10 million such positions contribute to a persistent labor shortage. This situation drives a compelling need for advanced automation solutions capable of filling these gaps, especially in environments designed primarily for humans. General-purpose humanoid robots are emerging as a particularly promising solution, designed with the versatility to operate within these human-centric spaces and perform a wide range of tasks traditionally undertaken by people.

As industries increasingly adopt automation and robotics to enhance productivity and improve workplace safety, the demand for sophisticated robotic systems, including humanoid robots, is rapidly growing. These robots offer the potential to work alongside human counterparts, adapting to dynamic conditions. However, realizing this potential requires overcoming substantial technical hurdles inherent in humanoid robot design, particularly concerning balance, stable mobility, and overall operational safety. Furthermore, many existing robotic solutions are specialized for narrow, repetitive tasks and lack the adaptability needed for seamless integration into diverse and complex workplace settings, highlighting a gap for more advanced, versatile platforms.

To mitigate risks associated with instability and facilitate safe operation during important phases such as training, maintenance, and deployment in challenging scenarios, support systems like tethers and harnesses are important. These systems provide essential stability and act as a safeguard against falls, which could otherwise result in significant damage to the robot or its surroundings. However, conventional tethering and harness solutions often present their own set of limitations. Many existing designs can unduly restrict the robot's range of motion, interfering with its ability to perform tasks effectively and navigate complex spaces, and do not accommodate a neck portion that has multiple degrees of freedom. Moreover, poorly designed tethers can potentially introduce new safety risks or hinder the very agility that makes humanoid robots advantageous. Therefore, a clear need exists for a harness system specifically designed for general-purpose humanoid robots.

### SUMMARY OF INVENTION

The presently disclosed subject matter is directed to a harness system for a humanoid robot. Particularly, the system comprises a textile harness configured to be removably secured to a torso of the humanoid robot, the textile harness including a chest portion and a back portion connected by shoulder portions (e.g., shoulder straps), wherein the textile harness comprises multiple layers including a compliant, deformable layer configured to absorb energy from external impacts, a soft underlayer positioned to prevent scratching of the torso, and a tough outer layer providing tensile strength. The harness system includes attachment anchors positioned on the shoulder portions for coupling the harness to an overhead support system, wherein the attachment anchors comprise textile loops sewn into the shoulder portions. The system includes frame couplers extending from the textile harness and configured to engage with recesses defined in a waist of the humanoid robot, wherein the frame couplers are configured to transfer suspension forces from the chest portion and back portion to the waist of the humanoid robot. The system includes at least one grab handle (e.g., rear handle and/or auxiliary handle) arranged on the back portion of the textile harness for manual manipulation of the humanoid robot, wherein the at least one grab handle includes both a rear handle 3114 (e.g., a rigid grab handle) and an auxiliary handle 3112 (e.g., a soft grab handle formed as a textile loop).

The presently disclosed subject matter is directed to a method of securing a humanoid robot. Particularly, The method comprises positioning a textile harness on a torso of the humanoid robot, the textile harness including a chest portion and a back portion connected by shoulder portions, wherein the textile harness comprises multiple layers including a compliant, deformable layer, a soft underlayer, and a tough outer layer. The method includes engaging frame couplers extending from the textile harness with recesses defined in a waist of the humanoid robot, wherein the frame couplers include harness straps that pass through apertures in waist couplers. The method includes coupling attachment anchors positioned on the shoulder portions to an overhead support system, wherein the attachment anchors comprise textile loops sewn into the shoulder portions. The method includes providing at least one grab handle on the back portion of the textile harness for manual manipulation of the humanoid robot, wherein the at least one grab handle includes both a rigid rear handle and a soft auxiliary handle formed as a textile loop.

The presently disclosed subject matter is directed to a protective system for a humanoid robot.

The presently disclosed subject matter is directed to a tethering apparatus for a bipedal robot. Particularly, the apparatus comprises a vest-like structure adapted to fit over an upper body of the bipedal robot, wherein the vest-like structure comprises multiple layers including a polyethylene foam layer with a thickness between 1.75 mm and 2.25 mm, a microfiber cloth layer, and a rip-stop nylon layer with a 4-way stretch knit having a stretch between 25% and 80%. The apparatus includes shoulder harnesses extending from the vest-like structure and including reinforced anchor points, wherein the shoulder harnesses include continuous loops of high-strength webbing and bar-tack stitching along defined load pathways. The apparatus includes waist straps extending from lower portions of the vest-like structure and terminating in mechanical fasteners configured to engage with complementary structures on the bipedal robot, wherein the mechanical fasteners include couplers with positive locking mechanisms comprising spring-loaded pins. The apparatus includes at least one rigid handle affixed to a back portion of the vest-like structure, wherein the rigid handle is affixed to a rigid support base plate layered within the vest-like structure. The apparatus includes at least one flexible handle affixed to the back portion of the vest-like structure, wherein the flexible handle is formed as a textile loop and is affixed to the rigid support base plate.

In an alternative embodiment, the protective system for a bipedal or humanoid robot comprises a harness body, potentially configured as a vest-like structure, constructed from multiple layers for protection and interfacing. This harness body may include a compliant, deformable inner layer, such as polyethylene foam approximately 1.75 mm to 2.25 mm thick, designed to absorb impact energy; a soft underlayer, like microfiber cloth less than 1 mm thick, positioned adjacent to the robot's torso to prevent scratching or marring; and a tough, protective outer layer, potentially a rip-stop nylon with a 4-way stretch knit (e.g., 25% to 80% stretch) and optional reflective elements, providing tensile strength and resistance to cuts and abrasions. The system features adjustable waist connectors for securing the harness, comprising waist straps extending from the harness body, adjustable buckles (which may include secondary, double-action release locking mechanisms), and couplers configured to engage corresponding recesses or features on the robot's waist portion. These couplers typically include a main body defining an aperture for the waist strap, a transverse body contacting the robot's waist surface, and an angular body with a projection extending into the waist recess. The inner surfaces of the couplers often incorporate a high-friction, compliant material, such as silicone rubber between 1 mm and 3 mm thick, to enhance grip and prevent damage to the robot's surface, and may further include a positive locking mechanism like a spring-loaded pin for secure engagement verification. Furthermore, the harness integrates features for managing peripheral devices, including cable management elements (e.g., fabric tunnels, elasticated loops, zippered channels), standardized interface connectors (such as sealed circular M12 connectors meeting IP67 ratings and providing multiple power levels like 5V, 12V, 24V), and standardized mounting points (like Picatinny rails MIL-STD-1913 and MOLLE webbing fields) with quick-release mechanisms for securely attaching and detaching auxiliary equipment such as tools, sensors, batteries, or communication devices.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect with, command, control, and/or interact with: (i) other humanoid robots, (ii) command center(s), (iii) cloud-based artificial intelligence system, (iv) data store, and/or network(s);

FIG. 2 is a block diagram illustrating components of the humanoid robot of FIG. 1 that include: (i) a mechanical and electrical architecture, (ii) a computing architecture including planner, behavior controller, perception system, onboard artificial intelligence system, and whole body controller, (iii) an input, output, and storage architecture that may include a plurality of sensors, a communication interface(s), and data storage(s), (iv) one or more processors, and (v) other components or architectures;

FIG. 3A is a perspective view of the humanoid robot showing the planes associated with said humanoid robot;

FIG. 3B is a diagram illustrating the actuators contained within the humanoid robot of FIG. 2-3A and the rotational axes of said actuators;

FIG. 4 is a perspective front view of a harness system coupled to the humanoid robot of FIG. 3A, where the harness system includes a textile harness, frame couplers, attachment anchors, and a handle and where the harness system extends over an upper extent of the torso and is coupled to the robot by frame couplers that secure at the waist;

FIG. 5 is a perspective rear view of the harness system coupled to the humanoid robot of FIG. 4;

FIG. 6 is a side view of the harness system coupled to the humanoid robot of FIG. 4, wherein the robot is standing an extended state to show the position of the frame couplers including the harness strap, waist couplers, and buckle;

FIG. 7 is a perspective rear view of the harness system coupled to the humanoid robot of FIG. 4, wherein the robot is standing an extended state;

FIG. 8 is an enlarged perspective side view of the harness system coupled to the waist of the humanoid robot of FIG. 7, where a waist coupler of the harness system is engaged within the anchor aperture of the harness support formed in the waist of the robot;

FIG. 9 is another enlarged perspective side view of the harness system coupled to the waist of the humanoid robot of FIG. 7, showing that the docking aperture remains accessible when the harness system is coupled to the robot;

FIG. 10 is a bottom view of the waist of the humanoid robot of FIG. 7, showing the harness supports of the waist, each including an anchor aperture and the docking aperture formed within the concave anchor recess;

FIG. 11 is an enlarged perspective view of the concave anchor recess of the waist of the humanoid robot of FIG. 7;

FIG. 12 is a front view of the harness system of FIG. 4, where dashed lines illustrate an arrangement of a front cross body band coupled the attachment anchors and the front harness straps positioned within the textile harness;

FIG. 13 is a rear view of the harness system of FIG. 12, where dashed lines illustrate an arrangement of a rear cross body band coupled the attachment anchors, the rear harness straps, and auxiliary handle positioned within the textile harness, and the rear hand coupled over the rear cross body band;

FIG. 14 is a left side view of the harness system of FIG. 12;

FIG. 15 is a right side view of the harness system of FIG. 12;

FIG. 16 is a perspective front view of the harness system of FIG. 12;

FIG. 17 is a perspective rear view of the harness system of FIG. 12;

FIG. 18 is a top view of the harness system of FIG. 12;

FIG. 19 is a bottom view of the harness system of FIG. 12;

FIG. 20 is an enlarged interior view of a waist coupler attached to the harness strap of the harness system of FIG. 12; and

FIG. 21 is an enlarged front view of a waist coupler attached to the harness strap of the harness system of FIG. 12.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The current workplace landscape is characterized by an unprecedented labor shortage, particularly evident in over 10 million unsafe or undesirable jobs across the United States. To address this growing labor deficit, there is a need for advanced robots capable of performing unappealing and hazardous workplace tasks. However, conventional robots may have limitations in their ability to operate effectively in human-centric environments. This creates a need for: (i) advanced robots capable of handling undesirable and hazardous tasks, or (ii) advanced robots capable of generating data that can be utilized to develop cutting-edge artificial intelligence models (e.g., LLMs, VLMs, VLAs, and/or BAMs) to enable these robots to operate autonomously in human-centric environments.

To generate data that can be utilized to develop cutting-edge artificial intelligence models (e.g., LLMs, VLMs, VLAs, and/or BAMs), interim models (e.g., LLMs, VLMs, VLAS, and/or BAMs) and/or teleoperation systems may be used to control the robot. However, said interim models may not be robust enough to ensure that the robot does not fall, or the teleoperator may cause the robot to fall due to misguidance. To avoid damaging the robot during these falls, a harness system that couples the robot to a suspension device or overhead support system (e.g., crane, gantry, rail system, cables, mobile support frames, or any other similar system). However, conventional tether systems may cause damage to the robot's neck when/if it falls, may centralize the force of the fall into a small or relatively small area, may not be capable of provide additional protection to the robot, and may not aid in moving the robot from a case or from a horizontal position. As such, there is a need for an advanced harness system that solves or improves upon the disclosed shortcomings.

The disclosed harness system solves or improves upon the shortcomings of conventional tether systems. As such, said harness system is designed to be donned (e.g., worn, like a vest or suspenders) on an upper extent of the robot's torso. The harness system provides attachment anchors and grip handles and can be coupled to an overhead support system (e.g., crane, gantry, rail system, cables) that allows the humanoid robot to move freely within its environment, while limiting the potential vertical displacement of the robot in the event that the robot becomes unstable, loses balance, stumbles, slips, falls, etc. The harness system can also provide locations where the humanoid robot can be gripped in the event that the robot falls and a human operator or another humanoid robot can assist in righting the fallen robot. Additionally, unlike conventional robot tethers that are coupled to the neck or arms, the disclosed harness system is coupled to the torso of the robot, and is “worn” by the robot similar to suspenders, a vest, or a safety harness. This helps ensure that said harness system does not limit the robot's range of motion or damage the arms, neck, or head of the robot. In addition, this design helps redistribute the force from the fall into the robot's waist and way from an upper extent, the moment arm is reduced and thus, less force is applied on a small region of the robot.

The harness system includes: (i) a vest-like textile harness arranged about the robot's upper torso and upper extent of the robot torso (e.g., interior to the shoulders), (ii) attachment anchors secured or formed in an upper extent of the harness (e.g., at an upper extent of the robot torso between the shoulders and head), (iii) a grab handle secured or formed in a thoracic region, and (iv) a frame coupler extending from the harness to the robot's lower torso or waist. The vest-like harness can provide additional protection to the robot, while said robot is collecting data. Also, the attachment anchors and grab handles are configured to receive an extent of a frame coupler, human or robotic hands, or other supports, and transfer the energy associated with the support into other robot structures, namely the internal frame of the robot. Accordingly, the attachment anchors and grab handles are designed as structural members that can support some or the entire weight of the robot and will not substantially deform in light of the stresses placed on said members if the robot needs to be suspended for repair reasons or aided back onto its feet after a fall. Unlike conventional suspension arrangements, the disclosed harness system is free of a single-point overhead clip attached to an arbitrary location on the robot body, and does not require a connection at the neck or at the arm assemblies to support the weight of the robot. The harness system is devoid of human-anatomical sub-pelvic, thigh, or seated-lifting straps, and is instead dimensioned and routed to engage the particular waist geometry of a humanoid robot whose lower torso includes structurally reinforced harness supports specifically formed to receive the frame couplers of the harness system.

The harness system is designed to be removably secured to the robot and provide attachment anchors that can be removably connected to a stabilizer frame via a pen or clip. By not forming the attachment anchors integral with the inner torso frame, the harness system can be selectively removed. This is beneficial because it allows the robot to receive other harness systems that a customer or user may require to use the robot in their factory, facility, home, or other environment. To further the ability for the robot to be adapted for use in a specific factory, facility, home, or other environment, the harness system utilizes a quick-release design that allows the user or owner of the robot to quickly and efficiently alter the type of harness system that the system uses. This again provides substantial benefits over conventional robots or harness systems that lack this capability. Unlike approaches in which suspension, cable routing, thermal management, or protective features are formed integrally with the robot's external skin, housing, or structural frame, the disclosed harness system is devoid of integrally formed suspension or lifting hardware and does not require modification of the robot's housing, exterior, or structural frame to add, remove, or reconfigure peripheral-mounting capability. Because the harness system is donned like a vest over the upper torso and secured at the waist by engagement of the waist couplers with the anchor recesses of the harness supports, the harness system may be removed when not required, swapped for a different harness configured to a different mission (including, for example, a harness configured with different peripheral-mounting modules, or a harness from which the fall-arrest attachment anchors have been omitted after the robot has completed a training phase), or transferred between multiple humanoid robots of comparable form factor.

Unlike conventional robots, the vest-like or suspender-like harness system is not integrally formed with the extent of the torso. This allows said harness system to be removed when it is not needed. Said vest-like or suspender-like harness system includes multiple soft (e.g., textile, rubber) attachment anchors and grab handles designed to be coupled to an overhead support system or grasped manually. The soft design of the attachment anchors provides substantial benefits over conventional robot tethers and harness systems that are formed from hard materials (e.g., rigid plastic or metal), wherein one of these substantial benefits includes preventing the tether or harness system from damaging the robot's body or surroundings during a fall. Additionally, the attachment anchors, grab handles, and/or additional anchor points can be used to mount or carry cargo, peripherals, or tools (e.g., like a utility vest).

Unlike conventional robot tethers and harness systems, the disclosed harness system is detachable from the robot and can be utilized temporarily or attached to a different robot if the operational needs have changed. For example, the harness system can be utilized during a training period when the humanoid robot is learning new tasks or moving in a small area, then be removed once the robot has learned the tasks. In a training situation, the harness system can also provide support to the robot should the robot become entangled in a data connection, power, or other cabling that may also be coupled to the robot. The harness system may also be utilized in certain environmental or hazardous situations.

Various embodiments of the harness system is designed to: (i) provide secure grab and anchoring points on the robot, (ii) support the weight of the robot, (iii) support the weight of payloads for the robot to carry, and (iv) be removable, replaceable, customizable, and/or modular. This configuration helps provide non-permanent attachment and/or lift points to the robot that can be easily changed or customized for different tasks as easily as changing a vest. For the above reasons, the design and arrangement of the actuators and their various supporting components provide the disclosed robot with substantial benefits over conventional robots and harness/tether systems.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

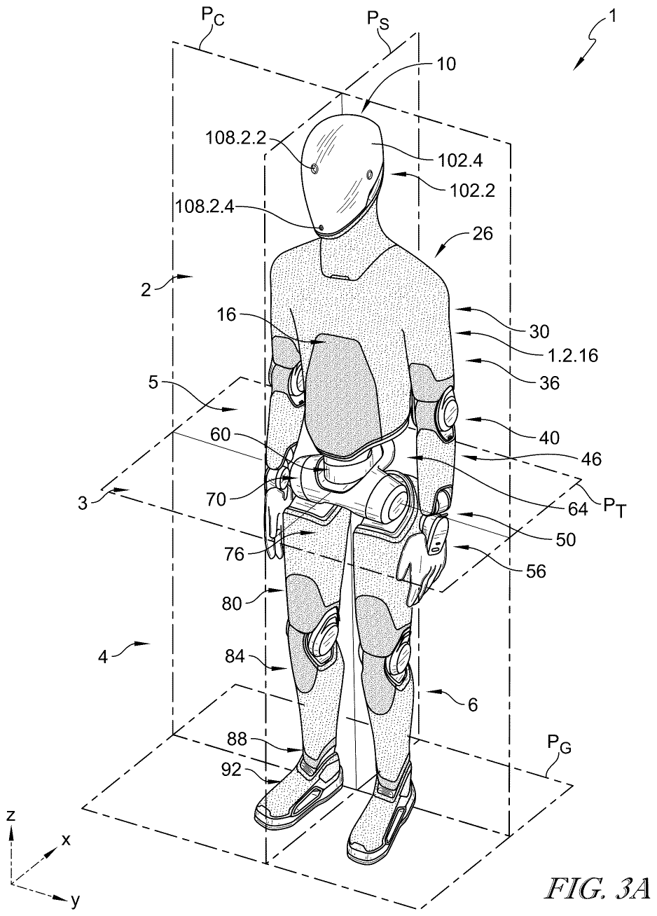

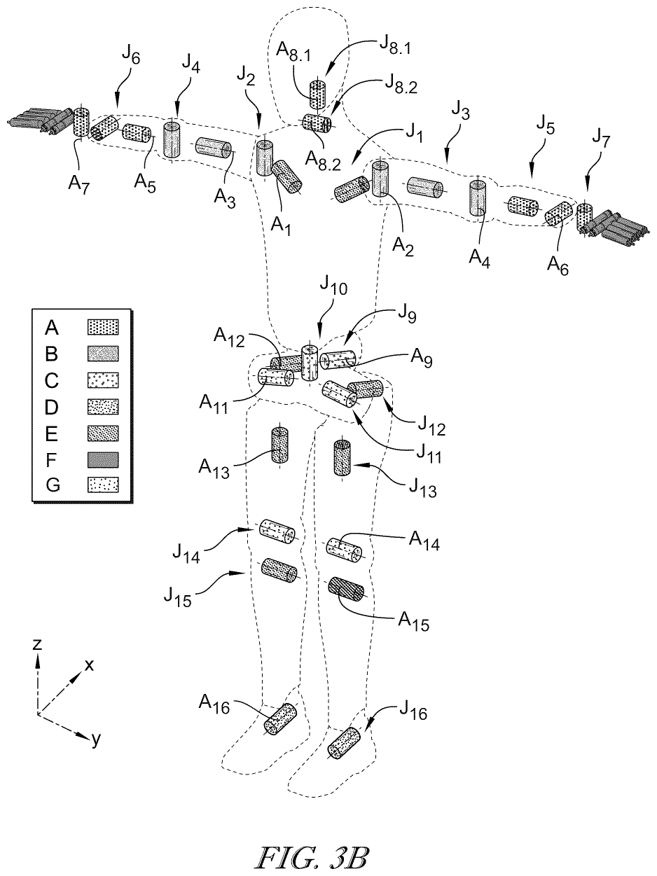

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

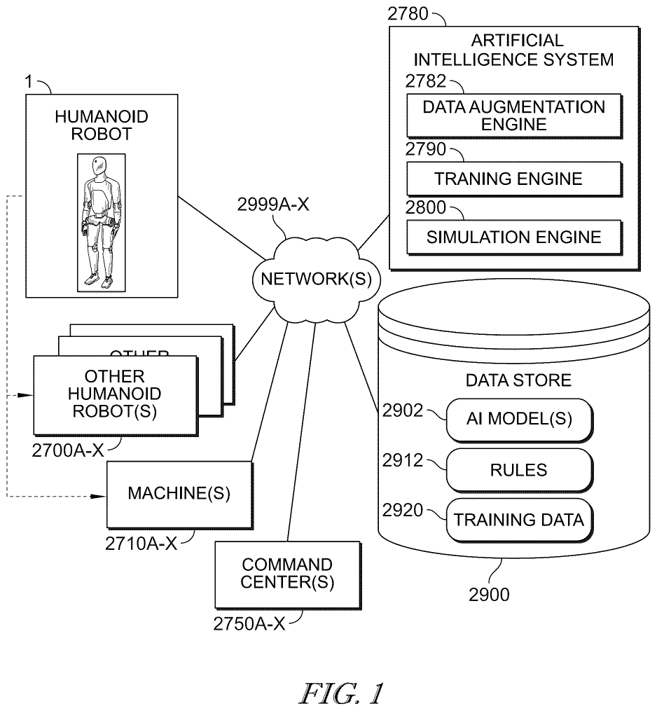

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

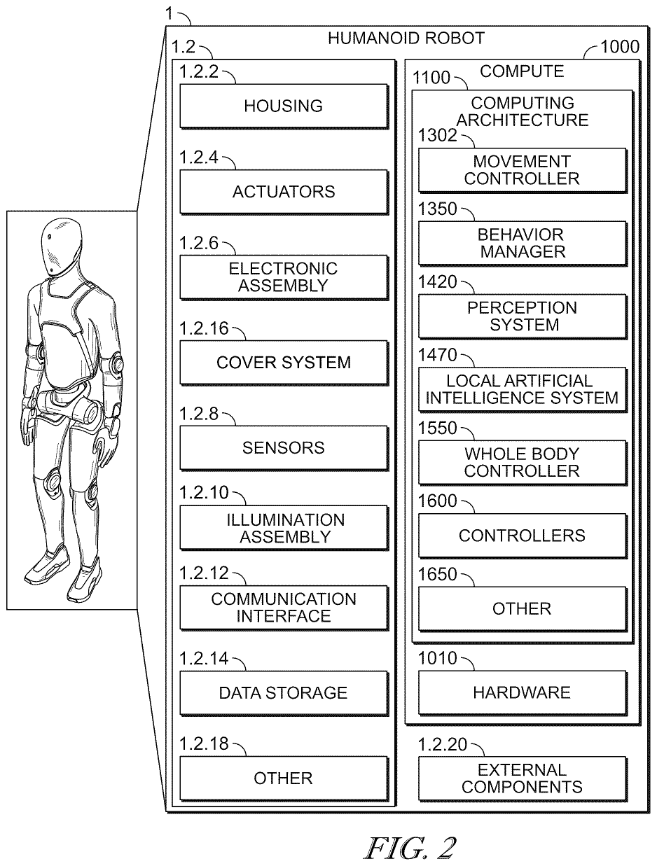

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane (P_{S}) but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane (P_{S}). This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist 604 and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

a. Torso Housing

The torso 16 is designed with various structural features, protective assemblies, and safety systems to protect the internal components of the robot 1 from damage from an impact, such as a fall. In particular, the torso 16 includes a torso housing 162 is designed to carry the majority of the structural loads of the robot 1 and couples to the waist 604 to further distribute the load to other structures and/or housings, such as the lower portion of the robot 1. In various embodiments, a torso housing 162 may include additional structural features to direct stresses and/or loads along predetermined load paths to protect the battery pack and other internal components. Further, an upper rear extent (e.g., the cervical-thoracic junction) of the robot housing 162 may include vent ports 176.6 configured to exhaust air delivered through the cooling system.

To house and protect the arm actuators (J1) and the electronic assembly 1.2.6, the torso housing 162 has a main skeleton that substantially defines the shape of the torso 16 and a rear panel that couples to the main skeleton. The main skeleton may be formed by one or more casing sections and is designed to offset and redistribute most of the loads that the robot 1 experiences while it performs various activities, tasks, and movements. For example, the main skeleton may include a front section, a left side, and a right side. As such, the main skeleton includes at least one region, and preferably several regions, that have been selectively thickened. The thickness of the main skeleton may vary from less than 1 mm to over 20 mm.

Overall, the selectively thickened regions have been designed to reduce or minimize the weight of the torso 16 while still providing proper structural support to allow for the redistribution of loads. Implementing varying thicknesses in the main skeleton provides robot 1 with substantial advantages over conventional robots that lack a main skeleton with variable thicknesses. The main skeleton is designed to carry the majority of the structural loads. The rear panel couples to the main skeleton and may be detached to provide access to a battery pack and other components housed within the torso 16. In some embodiments, the rear panel may additionally include thickened regions configured to distribute loads. Unlike conventional robots, the torso 16 is purposely designed with a complex geometry.

The torso housing 162 couples to the waist 604 to form a compartment for the electrical assembly, actuators, and other components housed within the internal volume. The main skeleton of the torso housing 162 is designed to transfer at least a portion of the loads to the waist 604. In some embodiments, the rear panel couples to the main skeleton to complete the load-bearing and/or transferring portions of loads through the torso housing 162.

In various embodiments, the torso housing 162 may be covered by one or more components of the cover system 1.2.16. For example, the torso may be covered by a torso cover 174 coupled to at least the torso housing 162 that covers the torso 16, shoulders 26, upper humerus 30, and lower humerus 36. One or more regions of the torso cover 174 may be configured with a porous weave pattern in a position that aligns with the airflow path to allow for venting to address thermal considerations.

### 3. Waist

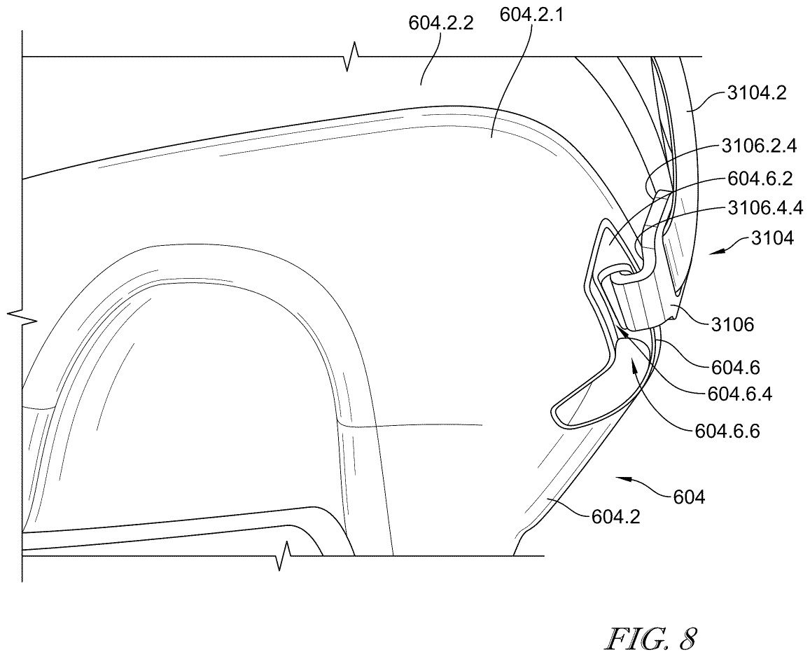

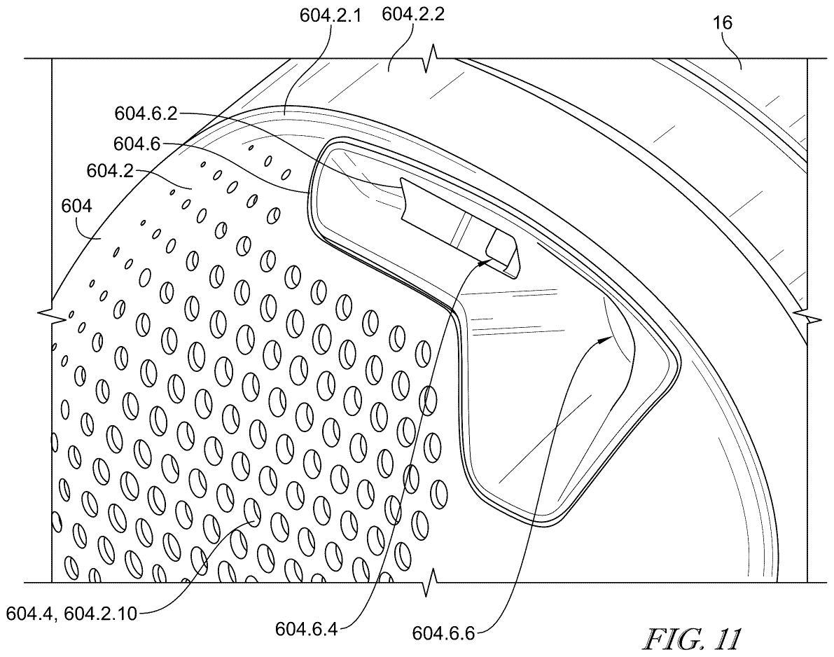

As best shown in FIGS. 8-11, the waist 604 of the spine 60 includes: (i) a waist body 604.2, (ii) perforated vent panels 604.4, and (iii) a pair of harness supports 604.6. The waist body 604.2 is shaped and contoured to transition the form of the robot 1 from the torso 16 to the pelvis 64. Specifically, the waist body 604.2 includes: (i) a main body 604.2.1 with a waist rim 604.2.2, and (ii) a projecting actuator housing or waist bucket 604.2.4 (also referred to herein as the waist bucket) that extends therefrom. The projecting actuator housing 604.2.4 is configured to receive the spinal twist actuator (J10) that couples the torso 16 to the pelvis 64 and downwardly depends from the shallow, parabolic-shaped main body 604.2.1.

Because the spine 60 is the only connection between the torso 16 and the pelvis 64, the waist 604 must be capable of transferring at least a portion of the load the robot 1 undertakes while performing a task. This transfer usually occurs from the arms 5, through the torso 16, and into the legs 6. As such, the waist body 604.2 includes a plurality of casing attachment supports that have additional thickness in the waist body 604.2 to transfer loads from the torso housing 162 into the waist bucket 604.2.4. The main body 604.2.1 of the waist body 604.2 has a shallow parabolic shape with a height that is significantly less than its width. This shallow main body 604.2.1 provides a curvilinear bottom shelf for the torso 16 that has a substantial area. This large area has a limited slope, which helps maximize the volume of the torso 16 and provides additional stability to the robot 1. The larger torso volume and additional stability is a substantial benefit over conventional robots that have very narrow lower torsos.

The intersection between the main body 604.2.1 and the actuator housing 604.2.4 forms an angle that is between 90 degrees and 120 degrees. This sharp angle furthers the concept that the main body 604.2.1 does not include a steeply sloped wall that narrows down to the diameter of the spine actuator. As shown in the figures, the projecting actuator housing 604.2.4 is not centered within the main body 604.2.1 and instead is offset towards a forward-most extent of the torso 16.

As shown in FIGS. 8-11, the underside of the main body 604.2.1 includes a pair of harness supports 604.6 formed in the left and right portions of the waist 604 to provide anchoring positions for the detachable harness system 3100. The harness supports 604.6 are formed in a structurally reinforced extent of the waist 604 and configured to support the weight of the torso 16 and upper portion of the robot 1. For example, the waist main body 604.2.1 may include thickened regions configured to distribute loads that align with load paths of the torso 16. In particular, each harness support 604.6 defines a concave anchor recess 604.6.2 having at least an anchor aperture 604.6.4 configured to engage with waist couplers 3106 of the harness system 3100. In the illustrative embodiment, the concave anchor recess 604.6.2 also includes a docking aperture 604.6.6 configured to receive a docking arm of a support stand. In various embodiments, the anchor recesses 604.6.2 are configured to provide a surface that can be grasped directly by human or robotic hands to support the robot 1, if needed. Unlike conventional humanoid torso or waist architectures, the waist 604 of the disclosed robot 1 is not devoid of engineered harness anchoring structure; rather, the waist 604 includes a dedicated pair of concave anchor recesses 604.6.2 sized and oriented to receive a textile-harness-borne coupler having the main-body, transverse-body, and angular-body-with-projection geometry described herein, and is free of reliance on a single arbitrary overhead clip point to support the robot 1.

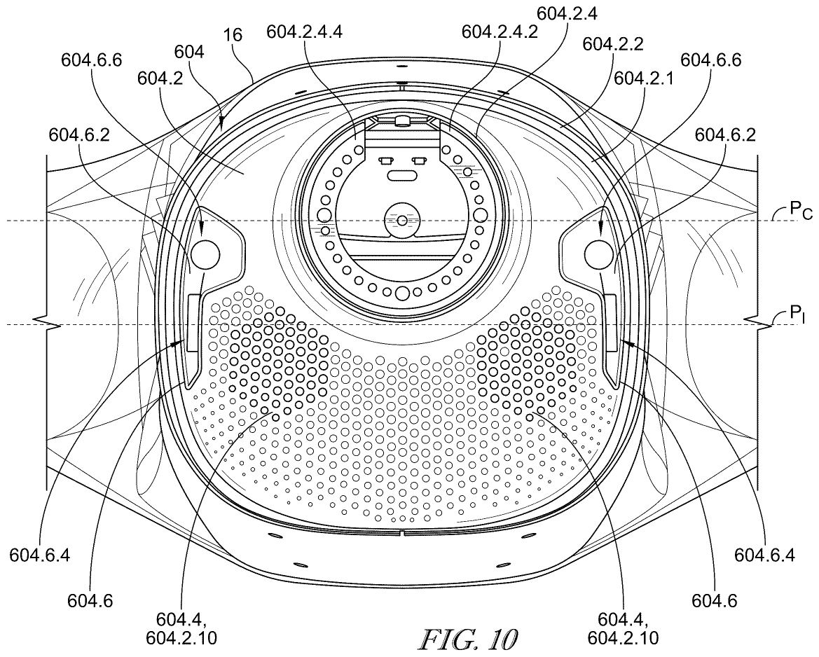

As shown in at least FIG. 10, the pair of harness supports 604.6 may be positioned rearward of the coronal plane (P_{C}), with the anchor apertures 604.6.4 centrally located at the periphery to substantially maintain the balance of the robot 1 and to minimize tipping forward or backward when suspended. In the illustrative embodiment, the anchor apertures 604.6.4 are centered about a vertical torso plane (P₁) that is parallel to the coronal plane (P_{C}) and contains a point defining the center of gravity for the torso 16. Locating the harness supports 604.6 at the periphery and in plane with the center of gravity, facilitates the coupling of the harness 3100 and allows the robot 1 to remain substantially upright when suspended by the harness 3100. In some embodiments, the placement and configuration of the harness support 604.6 may be designed based upon Finite Element Analysis (FEA) and/or topology optimization analysis to ensure the system has the required strength while minimizing adverse effects on the robot's balance, agility, and stability. The pair of harness supports 604.6 are oriented and paired across the sagittal plane (PS) of the robot 1 to cooperate with the waist couplers 3106 of the harness system 3100, such that the suspension force path proceeds from the attachment anchors 3108, through the internal strapping arrangement 3110, through the frame couplers 3104, and into the structurally reinforced anchor recesses 604.6.2.

Additionally, the waist body 604.2 may include vent openings 604.2.10 and/or perforated vent panels 604.4 designed to allow the flow of air into and/or out of the robot 1 to aid in cooling the robot's computer or battery. For example, the cooling system may be configured to draw in air through perforated vent panels 604.4 in the waist 604, through the torso 16, and exhaust air through vent ports 176.6 at an upper rear extent of the robot 1. The harness supports 604.6 are positioned such that the vent openings 604.2.10 are not obstructed when the robot 1 is engaged with the harness system 3100 and/or a docking support.

### 4. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 5. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 2

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts.

A substantial majority of the actuators 1.2.4 (e.g., about twenty-eight of the forty-two actuators or about 66.7% of the actuators) in the illustrative embodiment robot 1 are not connected to a drive linkage; instead, they directly drive the associated part of the robot 1. Conversely, in the illustrative embodiment robot 1, fourteen of the forty-two actuators 1.2.4, or about 33.3% (but more than 10%, and preferably more than 25%), of the rotary actuators are coupled to a drive linkage. Drive linkages are coupled to an aggregate total of twelve rotary actuators contained within both hands 56 and to the foot flex actuators (J15) in each shin 84. These drive linkages allow: (i) the fingers and thumb to be under-actuated, meaning they retain the ability to flex, curl, or rotate around an object while eliminating the need for an actuator to control each joint or degree of freedom, and (ii) the foot 92 to pivot around an axis that is located well forward (e.g., more than 10% of the overall length of the foot) of the center of the drive linkage.

The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. Cover System

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The requirements of the housings 1.2.2 can vary in shape and form based on the individual structural or material requirements for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load requirements. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the cover system 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlie the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D3O®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and a hand cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior covering materials of the cover system 1.2.16 can be made from one or more textiles and can be customized or selected to reduce wrinkling and to allow for the twisting or movement of the underlying components without restriction or substantial distortion. For example, the exterior covering materials may be designed to allow the lower arm to twist and rotate from about −120 degrees to about 180 degrees. Additionally, the exterior covering materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior covering materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior covering material can include reflective yarn or night-luminous yarn that changes its appearance when light is shining on its surface. In other embodiments, a shiny, reflective, iridescent, matte, or textured polyurethane film can be applied to the surface of the exterior covering material (e.g., a textile) in certain areas to provide an additional reflective effect or for another purpose, such as displaying a logo, pattern, or labels.

The exterior covering material can also include features to accommodate the thermal considerations of the robot 1. In various examples, the exterior covering material can be a custom textile that utilizes different weaves in different locations to allow for ventilation in specific areas. Additionally, the exterior coverings material can include textiles or threads that are heat-sensitive and change color with a change in temperature. In summary, the exterior covering may additionally be made from, include, or specifically omit any one or any combination of the following material types: durable materials, flame-resistant materials, waterproof materials, hazard materials, chemical-resistant materials.

Alternatively or additionally, the cover system 1.2.16 may include features such as closures (e.g., a zipper that runs a partial or full length of the cover system 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The cover system 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

### 3. Materials of the Exterior Covering Assembly

The cover material of the external coverings can be made from highly durable materials that have high stretch and are resistant to pilling, abrasions, and cuts. The cover material can include any known material, including but not limited to cotton, polyester, nylon, linen, wool, rayon, modal, viscose, Tencel, elastane (spandex), acrylic, denim, chambray, poplin, tweed, fleece, velvet, canvas, recycled polyester, microfiber, Lycra, gabardine, broadcloth, batiste, chiffon, georgette, tulle, mesh fabric, pique knit, interlock knit, rib knit, seersucker, brocade, herringbone weave, jacquard fabric, polyvinyl chloride (PVC), polyurethane (PU), thermoplastic polyurethane (TPU), ethylene vinyl acetate (EVA), polyethylene (PE), polypropylene (PP), low-density polyethylene (LDPE), elastomers, thermoplastic elastomers (TPE), nylon (polyamide), flexible polycarbonate, plasticized PVC, soft silicone, latex, neoprene, synthetic rubber, soft vinyl, flexible acrylic, bioplastics, and polyester blends with thermoplastics. It may also include fluoropolymers, plastic foams (memory foam blends), polyethylene terephthalate (PET) sheets, thermoplastic polyurethane (TPU) sheets, polypropylene (PP) sheets, polycarbonate sheets, polyvinyl chloride (PVC) sheets, polymethyl methacrylate (acrylic) sheets, high-density polyethylene (HDPE) sheets, fluoropolymer sheets (e.g., PTFE), flexible vinyl sheets, plasticized film sheets, rubberized polymer sheets, ethylene vinyl acetate (EVA) sheets, thermoformed polymer sheets, heat-sealable polymer sheets, antimicrobial polymer sheets, translucent polyethylene sheets, flexible PVC blends, breathable polymer films, coated polymer fabrics, microporous plastic sheets, stretchable polymer films, polyimide sheets, UV-resistant polymer films, electrically conductive polymer sheets, reinforced polymer films, eco-friendly polymer laminates, elastomeric films, neoprene, softshell fabrics, E-PTFE membranes, and rubberized fabrics.

Furthermore, materials may include mesh polymers, plastic-coated textiles, reflective fabrics, phase change materials (PCMs) for thermal regulation, graphene-infused fabrics, smart fabrics with sensors, hydrophobic nanocoated fabrics, Kevlar® reinforced fabrics, carbon fiber-infused textiles, fire-retardant textiles, shape-memory polymers, UV-blocking fabrics, biodegradable plastics for wearable use, conductive fabrics (for wearable electronics), gel-layered fabrics, insulative aerogels, aluminized fabrics, electrospun nanofibers, polylactic acid (PLA) fabrics, self-healing polymers, flexible optical fabrics, fluorescent/glow-in-the-dark polymers, antistatic polymer blends, and nanoparticle-infused fabrics, including transparent polymer films for garments. In other words, the use of the term “textile” herein is not limited to woven materials. The textile can be customized or selected to reduce wrinkling and to allow for twisting or movement of the underlying components without restriction or substantial distortion. For example, the cover material should allow an underlying component like the upper arm to twist and rotate from about −160 degrees to about 160 degrees.

An example material can be a 4-way stretch knit textile with a thickness of between 0.1 mm and 10 mm, and preferably between 1.75 mm and about 2.25 mm, with a stretch capacity between 0% and 100%, and preferably between 25% and 80%. In alternate embodiments, the cover material can include multiple weaves or patterns woven into a custom textile, with or without seams, and adapted to conform with the 3D features of the underlying robot 1. Further, the multiple weaves or patterns woven into a custom textile may include: (i) a reduction in the thickness or a looser weave of the torso cover in the cervical-thoracic junction to allow air to flow out from the torso cooling system; (ii) an indicator light positioned below the torso cover, wherein the light from said indicator light is visible from the exterior of said torso cover through a light-transmissive region; and (iii) a power button indicator that is coupled to the exterior of the torso cover and designed to show humans where the power button for the robot is located, which said button is obscured by the torso covering. In other words, the materials of the external covering system may be selected to allow for cooling, the viewing of lights, and/or the operation of buttons or indicator lights through said external covering. This provides a substantial benefit over conventional systems that lack these features.

It should be understood that this Application contemplates using or including materials in the external covering that: (i) integrate lights from the robot into said external covering, and specifically into the textile; (ii) may be translucent or temporarily translucent (e.g., time or environment-based); or (iii) can be woven in a manner that allows light to transmit through the textile. In some embodiments, the textile may be configured such that lights are visible through the textile, for example, fiber optic lighting, LED strip lights, LED rope lights, micro-LED string lights, LED neon flex, phosphorescent paint, OLED panels, laser diode lighting, neon tubing, electroluminescent panels, LED edge-lit panels, flexible LED sheets, flexible OLED strips, inductive electroluminescent displays, laser fiber cables, quantum dot light-emitting displays, phosphor-coated LED strips, laser-activated fluorescent materials, electroluminescent paint, laser-illuminated fiber bunches, phosphor-coated electroluminescent (PCEL) materials, smart RGB LED strips, light-up silicone tubing (LED or EL-based), laser wire, or other electroluminescent materials such as EL wire, EL tape, or EL film.

The textile can include reflective yarn or night-luminous yarn that changes appearance when light is shining on the surface. For example, the reflective yarn includes reflective material, which can reflect the light back to the original light source and provide a better reflective and warning effect. In various embodiments, a shiny, reflective, iridescent, matte, or textured polyurethane film can be applied to the surface of the textile in certain areas for an additional reflective effect or other purpose, such as displaying a logo, pattern, or labels. The cover material can also include features to accommodate the thermal considerations of the robot 1. In various examples, the cover material can be a custom textile, including various weaves within a single textile that allow for ventilation. The cover material can include textiles or threads that are heat-sensitive and change color with a change in temperature. For example, a heat-sensitive material can visually indicate that an underlying component is overheated.

In summary, the external covering system may be made from, include, or specifically omit any one or any combination of the following materials:
Reflective Textiles: retroreflective fabric, high-visibility (hi-vis) fabric, reflective nylon, microprismatic reflective film, Scotchlite™ reflective fabric, aluminum-coated fabric, reflective polyester, glass bead-coated fabric, reflective PVC, reflective tape integrated textiles.
Heat-Sensitive Textiles: thermochromic fabrics, phase-change materials (PCMs), color-changing fabrics (thermal reactive), smart fabrics with embedded sensors, thermo-responsive polymer blends, shape memory alloys integrated fabrics, temperature-regulating fabrics (e.g., Outlast®), heat-activated stretch fabrics.
Durable Textiles: Kevlar®, Dyneema®, Cordura®, ballistic nylon, ripstop nylon, heavyweight denim, waxed canvas, Teflon-coated fabrics, ultra-high molecular weight polyethylene (UHMWPE), aramid fiber blends, high-tensile polyester, nylon-spandex blends, canvas duck cloth.
Illuminant Textiles: fiber optic fabric, electroluminescent (EL) fabric, LED-embedded fabric, light-emitting fiber threads, glow-in-the-dark fabric, luminous fabric (photoluminescent), luminous yarn, solar-powered light-emitting textiles, organic LED (OLED) integrated textiles, phosphorescent fabric.
Flame-Resistant Textiles: Nomex®, CarbonX®, Pyrovatex® treated cotton, flame-retardant polyester, modacrylic blends, Indura® cotton, PBI (polybenzimidazole) fabric, Basofil® fabrics, treated wool.
Waterproof Textiles: Gore-Tex®, neoprene, polyurethane-coated fabric, DWR (durable water repellent) treated fabric, PVC-coated polyester, waterproof softshell fabric, TPU (thermoplastic polyurethane) laminated fabric, waterproof canvas.
Hazard Textiles: anti-static fabrics, arc-resistant fabrics, chemical splash protection fabrics, cut-resistant fabrics, flame-resistant hi-vis fabrics, biohazard protection fabrics, impact-resistant fabrics, radiation-protective fabrics, multi-hazard resistant workwear fabrics.
Chemical-Resistant Textiles: Tychem® fabrics, ChemMax® fabrics, polyethylene laminated fabric, butyl-coated fabrics, Viton®-coated fabrics, rubberized protective fabrics, fluoropolymer-coated fabrics.
   c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### E. Harness System

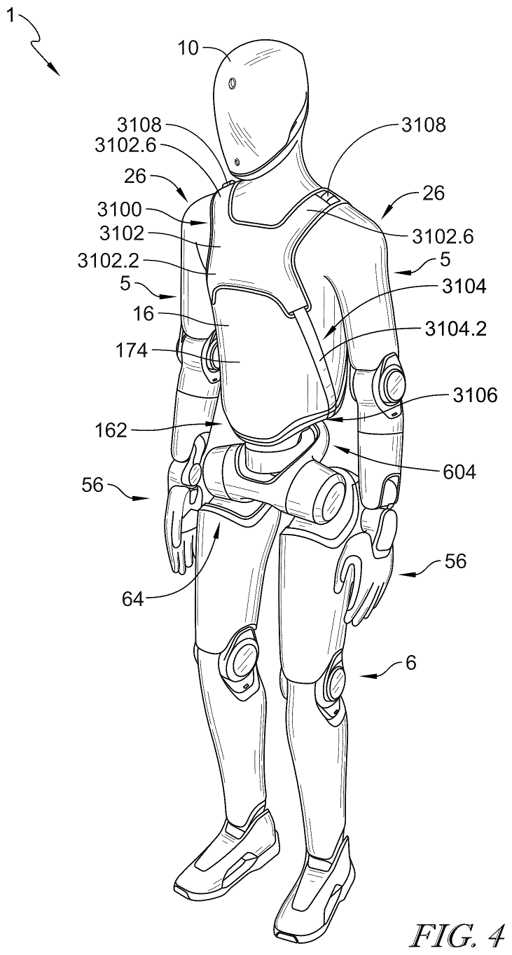

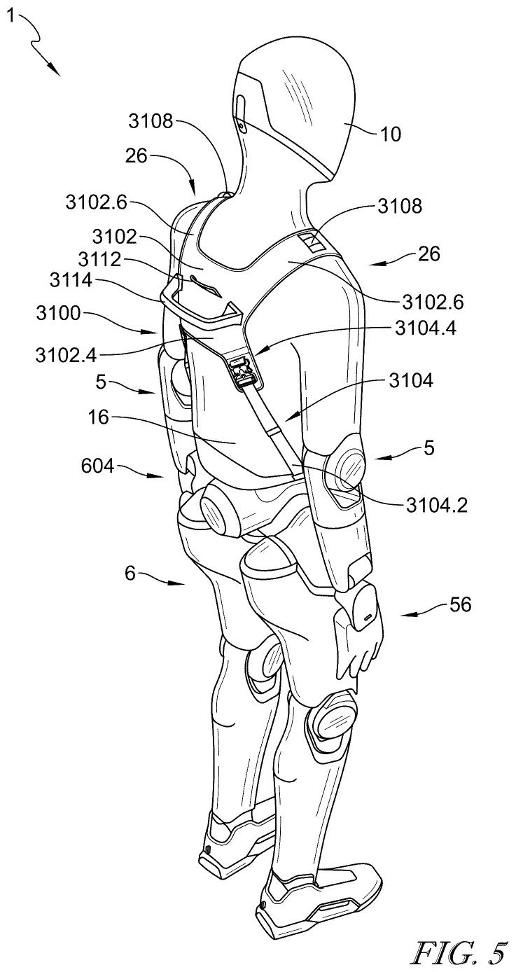

As shown in FIGS. 4-9, a harness system 3100 is a durable, form fitting, and removable apparatus that can be installed over the exterior surface of the robot 1 and secured to its structure to provide an interface for external support. The harness system 3100 includes: (i) a textile harness 3102 shaped to be worn over an extent of the robot's torso 16, (ii) a pair of frame couplers 3104 extending from a lower extent of the textile harness 3102 configured to couple to the waist 604 of the robot 1, (iii) a pair of attachment anchors 3108 coupled to an upper extent of the textile harness 3102 configured to be coupled to an external support system, and (iv) at least one grab handle secured to a rear extent of the textile harness 3102. For example, the at least one handle may include auxiliary handle 3112 (also called a soft grab handle) and/or rear handle 3114 (also called a rigid grab handle). The harness system 3100 is configured to have a snug fit and low profile (e.g., adding little additional thickness) against the torso 16 to allow robot 1 to move freely without impeding the movement of the head 10.1 or restraining robot 1 while performing tasks during normal operation. For example, the harness system 3100 does not move when the robot arms 5 change position (e.g., move from a neutral state to an extended state). The topology and form factor of the harness system 3100 are specifically matched to a bipedal general-purpose humanoid robot 1, such that the textile harness 3102 defines the chest portion 3102.2, the back portion 3102.4, and the shoulder portions 3102.6 interconnecting the chest and back portions, producing a vest-or-suspenders architecture that drapes over an upper extent of a vertically oriented humanoid torso 16. The harness system 3100 is free of strapping geometry routed around a sternum, underbelly, or withers of a horizontally oriented spine, and does not distribute suspension loads through a horizontally oriented quadruped load pathway. Likewise, the harness system 3100 is devoid of sub-pelvic, thigh, or seated-lifting straps, and is not dimensioned to conform to a human torso; the harness system 3100 is instead dimensioned and routed to engage the particular waist 604 geometry of the humanoid robot 1, whose lower torso includes structurally reinforced harness supports 604.6 specifically formed to receive the frame couplers 3104.

In various embodiments, the harness system 3100 further includes an internal strapping arrangement 3110 layered within the textile harness 3102 and configured to distribute loads applied to the torso 16, where the internal strapping arrangement 3110 provides load paths between the attachment anchors 3108 and the frame couplers 3104 and includes cross-body bands 3110.2, 3110.4 to distribute lateral forces. This arrangement provides attachment anchors 3108 at an uppermost extent of the torso 16 on both sides of the head 10.1 that are anchored to the waist 604 coupled to the torso 16. This arrangement helps ensure that the harness system 3100 does not limit the robot's range of motion or damage the arms 5 or head 10.1 of the robot 1. By coupling the harness system 3100 to the robot 1 at the waist 604 and in plane with the center of gravity of the torso 16, the robot 1 may remain substantially upright when suspended by the harness system 3100 at the attachment anchors 3108.

The harness system 3100 is configured to be attached to an overhead support system to limit unexpected movement and reduce damage to robot 1 in the event of an unplanned occurrence that may cause robot 1 to become unstable or fall. In some circumstances, the harness system 3100 may be used to fully support or suspend a robot 1. The harness system 3100 disclosed herein is designed to couple the robot 1 at the torso 16 to an overhead support system (e.g., crane, gantry, rail system, cables, mobile support frames, tether system, or any other similar system) via at least one line (e.g., cable, rope, strap, wire, cordage, chain, webbing, braided strands of elongated material, or other suitable means of attachment). This positional and coupling arrangement allows the humanoid robot 1 to move freely within its environment while limiting the potential vertical displacement of the robot 1 if said robot becomes unstable, loses balance, stumbles, slips, or falls. Additionally, unlike conventional robot tethers that are coupled to the neck or arms, the disclosed harness system 3100 partially surrounds the torso 16 and is coupled to the housing of the robot 1 at the waist 604 to support the torso 16. This arrangement helps ensure that the harness system 3100 does not limit the robot's range of motion or damage the arms 5 or head 10.1 of the robot 1.

The harness system 3100 is designed to prevent damage to the robot 1 in the event of an unexpected fall. Should the robot 1 lose its balance or footing, the harness system 3100 is engineered to support its full weight, preventing a direct impact with the ground. To ensure this reliability, the harness system 3100 and all its components are rated to withstand the maximum dynamic forces that the robot 1 can generate. The harness system 3100 is rated for the force that can be generated by the robot 1 moving at maximum speed, carrying the maximum payload capacity. This rating is calculated based on the robot's total mass, its maximum possible payload capacity, and the forces generated during its fastest possible movements and accelerations.

The harness system 3100 may be used during a teleoperation session and/or when the robot 1 is not operating in a fully autonomous mode, such as during programming, training, testing, or when undergoing maintenance or repairs, to ensure the safety of both the equipment and the personnel working in close proximity. The harness system 3100 is configured to mitigate risks associated with robotic operations, particularly during manual movement, training, and maintenance. The harness system 3100 can be used in combination with the robot 1 for the purpose of risk reduction of potential hazards associated with moving the robot 1 or training the robot 1. This harness system 3100 is designed to securely connect to the robot 1, providing a reliable method for a single person to maneuver the robot 1 while adhering to established safety guidelines that limit individual exertion. This significantly reduces the risk of musculoskeletal injuries to personnel and allows for efficient repositioning of the robot 1 without requiring a team of handlers.

The harness system 3100 is configured for handling and lifting the robot 1 and its associated components. For example, the harness system 3100 may be provided and configured to be adequate for handling the anticipated load. For example, the harness system 3100 may be coupled to or lifted by lifting hooks, eye bolts, threaded holes, or fork pockets. The harness system 3100 supports the robot 1 in the case of an unexpected loss of balance or fall and prevents damage to the robot 1 that may be caused by the fall. The harness system 3100 is removably secured to the torso 16 of the humanoid robot 1 and is not integrally formed with any part of the robot's structural frame, external housing, or skin. Accordingly, the harness system 3100 is free of integrally formed suspension or lifting hardware and does not require modification of the robot's own housing, exterior, or structural frame to add, remove, or reconfigure peripheral-mounting capability. Because the harness system 3100 is donned over the upper torso 16 and secured at the waist 604 by engagement of the waist couplers 3106 with the anchor recesses 604.6.2 of the harness supports 604.6, the harness system 3100 may be removed when not required, swapped for a different harness configured to a different mission (including, for example, a harness configured with different peripheral-mounting modules, or a harness from which the fall-arrest attachment anchors 3108 have been omitted after the robot 1 has completed a training phase), or transferred between multiple humanoid robots of comparable form factor.

a. Textile Harness

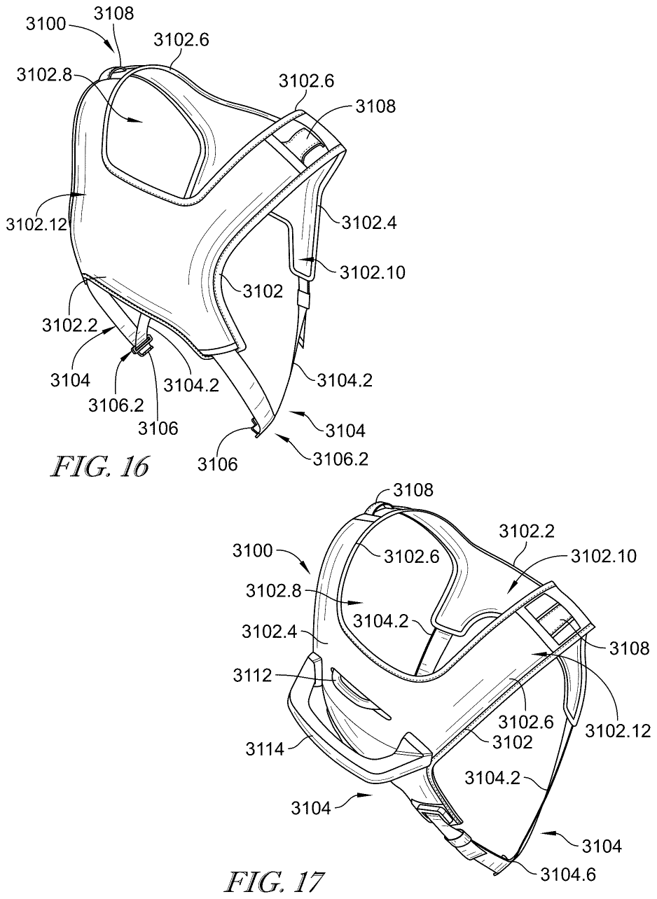

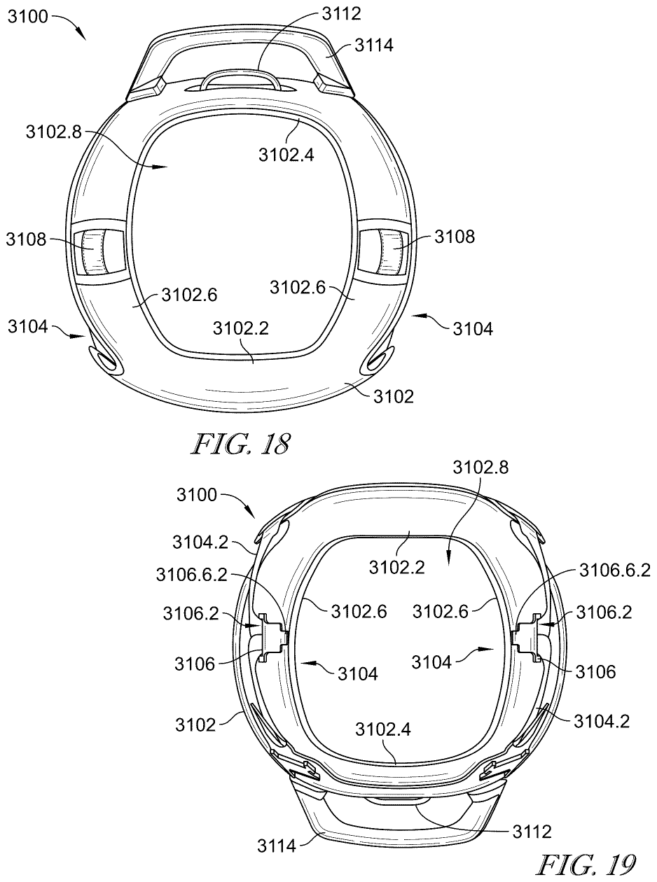

As shown in FIGS. 4-7 and 12-19, the textile harness 3102 includes a chest portion 3102.2 (also called a front vest portion, a ventral portion, or an anterior portion), a back portion 3102.4 (also called a rear vest portion, a dorsal portion, or a posterior portion), and a pair of shoulder portions 3102.6 (also called shoulder straps) that join the chest and back portions forming a neck opening 3102.8. The neck opening 3102.8 is configured to receive the robot's head 10.1 therethrough, such that the chest portion 3102.2 overlays a front extent of the torso 16 and the back portion 3102.4 overlays a rear extent of the torso 16. The shoulder portions 3102.6 are configured to be arranged over an uppermost extent of the torso 16, on the left and right sides between the head 10.1 and each shoulder 26. The multi-layer textile construction of the textile harness 3102 is tuned to the particular requirements of interfacing with a painted, coated, or otherwise finished non-biological humanoid-robot exterior, and the layering sequence described herein is free of the ventilation-first architecture characteristic of coat-facing animal harnesses and is devoid of human ergonomic shaping, ballistic-plate retention pockets, and fall shock-attenuation webbing configured to arrest a falling-human body weight through human anatomical load paths.

In the illustrative embodiment, the textile harness 3102 includes a base panel 3102.10 (e.g., a first garment layer) and a cover panel 3102.12 (e.g., a second garment layer), where base panel 3102.10 defines the general shape of the textile harness 3102. The cover panel 3102.12 may substantially match the shape of the base panel 3102.10, where the cover panel 3102.12 includes a plurality of openings 3102.12.6 (e.g., cut out sections or slits) to accommodate the attachment anchors 3108, frame couplers 3104, and/or a handle 3112, 3114. For example, an extent of the attachment anchors 3108 and an extent of each frame coupler 3104 may be coupled to the base panel 3102.10 and substantially covered by the cover panel 3102.12. In the illustrative embodiment, an extent of the frame couplers 3104 and an extent of the attachment anchors 3108 are coupled to the front and rear cross-body bands 3110.2, 3110.4 forming an internal strapping arrangement 3110 secured between the base panel 3102.10 and cover panel 3102.12 of the textile harness 3102. In some embodiments, the cross-body bands 3110.2, 3110.4 are omitted, where one or both panels 3102.10, 3102.12 are configured to further distribute applied loads.

In the illustrative embodiment, the cover panel 3102.12 may include an attachment opening 3102.12.6.6 at each of the shoulder portions 3102.6 to allow access to the attachment anchors 3108 coupled to the base panel 3102.10. Similarly, the cover panel 3102.12 may include front strap openings 3102.12.6.2 on left and right lower extensions 3102.2.2 of the chest portion 3102.2 and rear strap openings 3102.12.6.4 on left and right lower extensions 3102.4.2 of the back portion 3102.4. In some embodiments, the cover panel 3102.12 may include a front cover section 3102.12.2 and a rear cover section 3102.12.4, where the front and rear cover sections 3102.12.2, 3102.12.4 are sized such that when coupled with the base panel 3102.10 the attachment openings 3102.12.6.6, the front strap openings 3102.12.6.2, and the rear strap openings 3102.12.6.4 are formed. The cover panel 3102.12 may be hemmed or reinforced at said openings to reduce wear. The base and cover panels 3102.10, 3102.12 are coupled to each other at least at a peripheral edge 3102.14 and the neck opening 3102.8. Further, the cover panel 3102.12 may include a handle opening 3102.12.6.8 formed in the rear cover section 3102.12.4 for the auxiliary handle 3112.

Each of the base panel 3102.10 and the cover panel 3102.12 may include one or more textile layers having predetermined properties. For example, the base panel 3102.10 may include individual textile layer(s) selected to: (i) supply tensile strength across the textile harness 3102 (e.g., to transfer force loads between the shoulder portions 3102.6 and the frame couplers 3104), (ii) protect the torso 16 and the textile harness 3102 from cuts, scratches, and point loads (e.g., punctures, etc.), and/or (iii) prevent the textile harness 3102 from scratching or marring the exterior surface of the torso 16 during use. In some examples, the base panel 3102.10 may include a soft underlayer (e.g., felt, terry cloth, microfiber cloth) to prevent scratching or marring the finish of the torso 16 during use. The cover layer 3102.12 may include a tough outer layer (e.g., canvas, woven nylon, rip-stop nylon) to provide tensile strength across the textile harness 3102 (e.g., transfer force loads between the attachment anchors 3108 to the frame couplers 3104) and protect the torso 16 from cuts, scratches, and point loads (e.g., stabbings). In some examples, an energy absorbing core layer may be provided between the base panel 3102.10 and the cover panel 3102.12.

In various embodiments, one or more of the textile layers may be selected from the cover materials listed herein with respect to the cover system 1.2.16. For example, the cover panel 3102.12 may include an exterior facing textile layer that is the same as, or similar to, an exterior facing textile layer of one or more cover members of the cover system 1.2.16. In certain embodiments, the base panel 3102.10 and/or cover panel 3102.12 may include one or more textile layers that are continuous over said panel. In certain embodiments, the base panel 3102.10 and/or cover panel 3102.12 may include one or more textile layers that cover only certain regions of said panel. The base and cover panels 3102.10, 3102.12 may be hemmed together at a peripheral edge 3102.14 and the neck opening 3102.8, where the hem can provide additional mechanical strength and prevent separation of the panels and/or textile layers of the panels. For example, the textile harness 3102 may further include a binding (e.g., strip or band of textile or bias tape) attached at the neck opening 3102.8 and/or peripheral edge 3102.14 to prevent fraying and separation.

In some embodiments, the base panel 3102.10 may include a contact textile layer of durable material that covers discontinuous contact regions beneath the attachment openings 3102.12.6.6, the front strap openings 3102.12.6.2, and the rear strap openings 3102.12.6.4 of the cover panel 3102.12. The contact textile layer may be continuous or comprise discrete sections that are sized to be greater than the individual openings of the cover panel 3102.12 to help reduce wear of the underlying base panel 3102.10 from coupling means of the overhead support system. For example, sections of the contact textile layer may be arranged between the attachment anchors 3108 and the base panel 3102.10 at the shoulder portions 3102.6, where the attachment anchors 3108 are accessed through the attachment openings. Similarly, sections of the contact textile layer may be arranged over the base panel 3102.10 at rear strap openings 3102.12.6.4 to reduce wear from the buckle 3104.4 of the frame couplers 3104. In some embodiments, the contact textile layer is a continuous layer that covers the base panel 3102.10. In some embodiments, the rear strap openings 3102.12.6.4 are formed as a slit in the cover panel 3102.12 at the lower extensions 3102.4.2 of the back portion 3102.4, such that an extent of the rear harness strap 3104.6 extends therethrough and the buckle 3104.4 of the frame coupler 3104 overlays a portion of the cover panel 3102.12.

Additionally, the textile harness 3102 may include an energy attenuation layer configured to absorb the energy of external impacts. The energy attenuation layer may be a continuous layer included within the textile layers of the base panel 3102.10 and/or cover panel 3102.12, or a discontinuous layer configured to provide protection in certain regions. For example, the chest portion 3102.2 and/or the back portion 3102.4 of the textile harness 3102 may include an energy attenuation region formed in the base panel 3102.10, the cover panel 3102.12, or coupled between the base panel 3102.10 and the cover panel 3102.12. The energy attenuation region may include one or more of the energy attenuation materials listed herein with respect to the energy attenuation members of the cover system 1.2.16. In some embodiments, the base panel 3102.10 may include an energy attenuation layer formed within the textile layers to provide a cushion between an internal strapping arrangement 3110 that may distribute forces applied to the torso 16 when the robot is suspended. For example, the textile harness 3102 may include a polyethylene foam layer with a thickness between about 1.75 mm and 2.25 mm arranged between a base panel 3102.10 having a microfiber cloth layer and a cover panel 3102.12 having a rip-stop nylon layer with a 4-way stretch knit. The multi-layer textile stack of the textile harness 3102 may be further tuned to robot-facing use by arranging, in order, a compliant impact-absorbing inner layer (e.g., polyethylene foam approximately 1.75 mm to 2.25 mm thick, and in various embodiments between about 1.5 mm and about 3 mm thick), an intermediate robot-facing soft underlayer (e.g., microfiber cloth less than 1 mm thick, and in various embodiments between about 0.3 mm and about 1 mm thick) sized to prevent scratching or marring of the painted, coated, or anodized finish of the torso 16, and a tough outer layer (e.g., rip-stop nylon with a 4-way stretch knit between approximately 25% and 80% stretch) providing tensile strength, cut resistance, and abrasion resistance while accommodating the range of motion of the underlying robot articulation. Unlike single-layer textile lifting slings, ballistic-plate carriers, coat-facing quadruped vests, or human fall-arrest carriers, the multi-layer stack disclosed herein is free of an exclusive-ventilation architecture directed to an animal coat, is devoid of a ballistic-plate retention pocket directed to a human wearer, and is not configured to arrest a human body weight through sub-pelvic or thigh strapping.

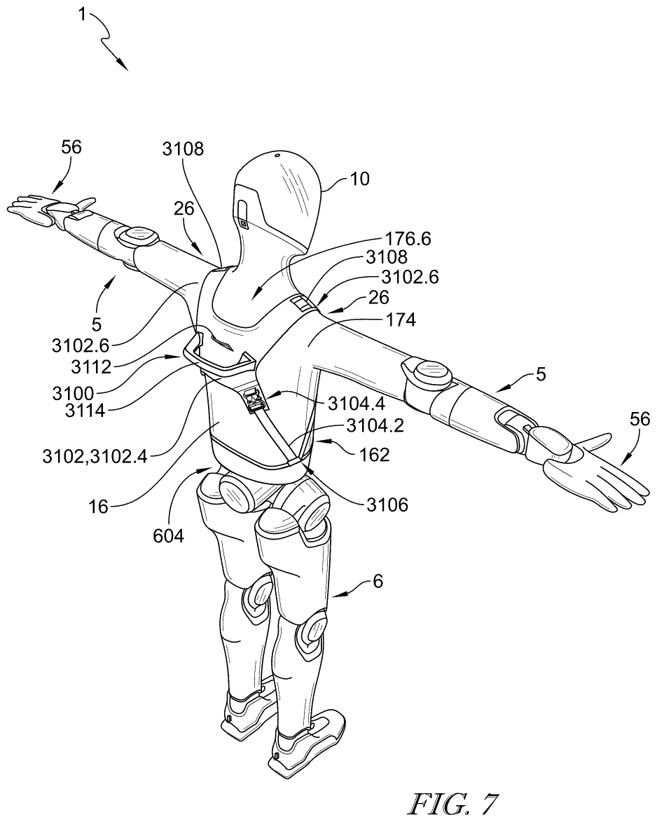

In some embodiments, the harness system 3100 may incorporate features specifically designed to promote airflow and facilitate heat dissipation away from the robot's torso 16. In the illustrative embodiment, the textile harness 3102 is shaped to accommodate ventilation and thermal regulation needs of the robot 1 and does not cover vent openings 176.6, 604.4 formed in the torso 16 or waist 604. For example, as shown in FIG. 7, the neck opening 3102.8 of the textile harness 3102 is sufficiently large such that the back portion 3102.4 of the textile harness 3102 does not cover the vent ports 176.6 hidden by the torso cover 174 at an upper rear extent of the torso 16 (e.g., the cervical-thoracic junction). In some embodiments, the harness system 3100 may include highly breathable materials, such as open-weave synthetic mesh textiles (e.g., polyester or nylon mesh with varying aperture sizes), perforated non-woven fabrics, or other materials exhibiting high air permeability and moisture vapor transmission rates. The selection and placement of these breathable materials can be optimized based on known heat concentration zones on the robot's torso 16, thereby maximizing passive heat exchange with the ambient environment.

b. Internal Strapping Arrangement

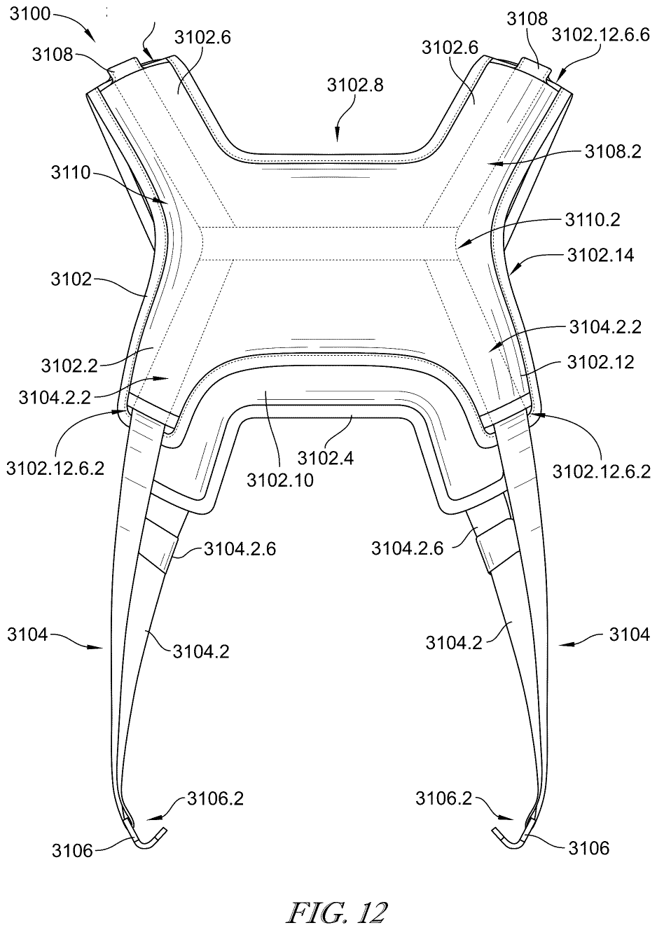

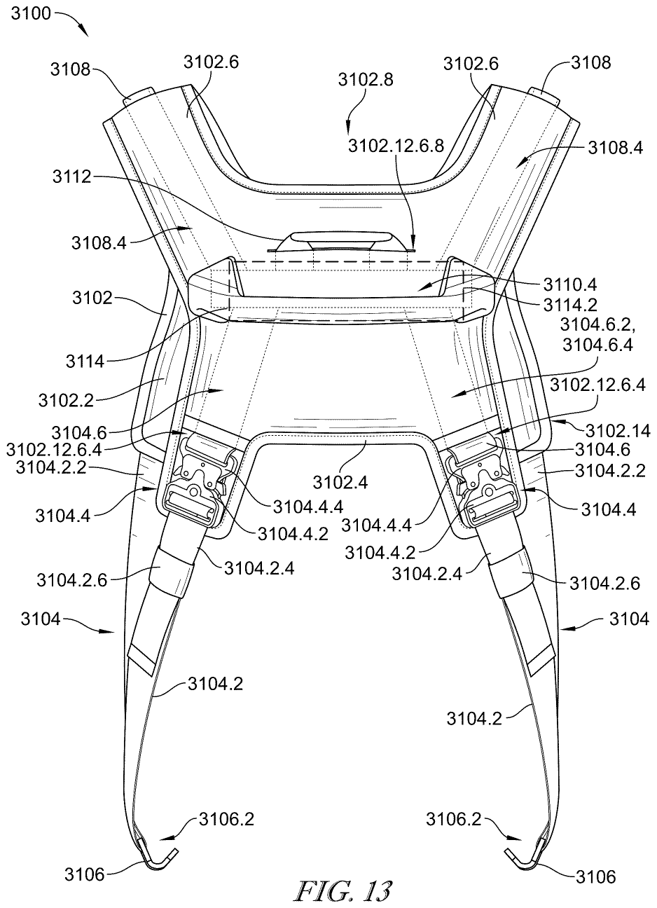

Referring to FIGS. 12-13, the harness system 3100 may include an internal strapping arrangement 3110 layered within the textile harness 3102. The internal strapping arrangement 3110 is configured to distribute loads applied to the torso 16 when the robot 1 is suspended or otherwise restrained by the external support system. For example, the textile harness 3102 may include front and rear cross body bands 3110.2, 3110.4 configured to provide load paths across the chest and back portions 3102.2, 3102.4 and may further be coupled to the attachment anchors 3108 and/or the frame couplers 3104. The components of the internal strapping arrangement 3110 may include high-strength webbing that is securely layered within the textile harness 3102 (e.g., between base panel 3102.10 and cover panel 3102.12) to optimize the transfer of forces, enhance overall structural integrity, and provide reinforced load paths. Additionally, bar-tack stitching or laminated structural layers could be employed along these defined pathways to ensure efficient force transmission primarily to the robot's waist 604 via the waist couplers 3106, minimizing stress on other harness areas or the robot's upper structure.

In the illustrative embodiment, the internal strapping arrangement 3110 includes: (i) front and rear cross body bands 3110.2, 3110.4, (ii) a pair of attachment anchors 3108 coupled to the front and rear cross body bands 3110.2, 3110.4, (iii) a pair of frame couplers 3104, where each frame coupler 3104 includes a front and rear harness strap 3104.2, 3104.6 coupled to the front and rear cross body bands 3110.2, 3110.4, respectively. The front and rear cross body bands 3110.2, 3110.4, the attachment anchors 3108, and the harness straps 3104.2, 3104.6 include sections of high-strength webbing arranged between and coupled to the base and cover panels 3102.10, 3102.12 of the textile harness 3102. In the illustrative embodiment, the cross body bands 3110.2, 3110.4 are separate webbing sections that extend over lateral sections of the chest and back portions 3102.2, 3102.4, respectively. In various embodiments, the internal strapping arrangement 3110 may be coupled directly to the base panel 3102.10, where the cover panel 3102.12 overlays the internal strapping arrangement 3110 and the base panel 3102.10. For example, the base panel 3102.10 is configured to provide a protective layer to minimize friction and rubbing between the high-strength webbing (e.g., attachment anchors 3108, frame couplers 3104) that may apply forces to the robot 1 when the harness system 3100 prevents a fall or collapse. The cover panel 3102.12 may be coupled to the base panel 3102.10 to cover the internal strapping arrangement 3110.

In some embodiments, the internal strapping arrangement 3110 includes cross-body webbing extending diagonally between the shoulder portions 3102.6 and the lower extents of the textile harness 3102, so that loads applied at the attachment anchors 3108 are not carried by the textile shell alone but are transmitted through the internal strapping arrangement 3110 into the frame couplers 3104 and ultimately into the harness supports 604.6 of the waist 604. Because the cross-body webbing is positioned within the multi-layer stack of the textile harness 3102, it is protected from abrasion, snagging, and direct contact with the robot exterior. Unlike cross-body webbing arrangements directed to human anatomy, the webbing of the internal strapping arrangement 3110 terminates not at hip D-rings or thigh buckles but at the frame couplers 3104, so that the internal strapping arrangement 3110 cooperates with the waist couplers 3106 to transfer suspension loads into the concave anchor recesses 604.6.2 formed in the waist 604. The internal strapping arrangement 3110 is free of human-anatomical termination points such as sub-pelvic hip D-rings and thigh buckles, and is devoid of a seated-lifting configuration intended to support a human body weight in a suspended seated posture.

In the illustrative embodiment, the internal strapping arrangement 3110 additionally includes an auxiliary handle 3112 formed by a textile loop. The auxiliary handle 3112 may be formed with or coupled to the rear cross body band 3110.4 and/or frame couplers 3104 via the rear harness strap 3104.6. The auxiliary handle 3112 is configured to extend outward through the handle opening 3102.12.6.8 formed in the cover panel 3102.12 of the textile harness 3102. Because the auxiliary handle 3112 is coupled directly to the internal strapping arrangement 3110, it may be used as an additional or alternative attachment point for an external support system.

c. Attachment Anchors

Referring to FIGS. 4-7, each shoulder portion 3102.6 of the harness system 3100 includes an attachment anchor 3108 positioned over an upper extent of the torso 16 interior to the shoulders 26 and are configured to handle hanging and fall loads. In the illustrated example, the attachment anchors 3108 are formed as textile loops that are sewn into or otherwise anchored to the shoulder portions 3102.6. For example, the attachment anchors 3108 may be reinforced by sewing or bonding such that the extent of the strap that forms the anchor is fixed to the textile harness 3102. By using a textile material, the attachment anchors 3108 are strong enough to bear the weight of the robot 1 but soft enough to not interfere with movement of the head 10.1 or cause marring. However, in some examples, the attachment anchors 3108 can be formed of a rigid material (e.g., metal, plastic, ceramic). Each attachment anchor 3108 is structurally integrated with the internal strapping arrangement 3110 so that a load applied at the attachment anchor 3108 is transmitted through the internal strapping arrangement 3110 and into the frame couplers 3104 engaged with the harness supports 604.6 of the waist 604. The attachment anchors 3108 are free of an isolated lift-point construction, and do not require a standalone sling topology unaccompanied by the disclosed waist-coupler-engaging humanoid anchor architecture.

In the illustrative embodiment, each attachment anchor 3108 includes a strip of a textile material (e.g., webbing) having a predetermined length. The attachment anchor 3108 includes a first end 3108.2, a second end 3108.4, and a central loop section 3108.6 configured to couple with the external support system. The attachment anchor 3108 extends over the shoulder portion 3102.6, where the first end 3108.2 is coupled to the front cross body band 3110.2 and a second end 3108.4 is coupled to the rear cross body band 3110.4. The attachment anchor 3108 is positioned such that the central loop section 3108.6 has a gap between the attachment anchor 3108 and shoulder portion 3102.6 of the textile harness 3102, where the gap is sufficient to receive means of attachment (e.g., hook or other connector) of an overhead support system. In the illustrative embodiment, the central loop section 3108.6 is configured to extend outward from the base panel 3102.10 through the attachment opening 3102.12.6.6 of the cover panel 3102.12 at each of the shoulder portions 3102.6. The attachment anchor 3108 may be further secured to the textile harness 3102 by additional sewing or bonding at the edges of the attachment opening 3102.12.6.6. In some embodiments, the central loop section 3108.6 may be substantially flush with the shoulder portion 3102.6, yet attached in a manner that the means of attachment of the overhead support system may couple with the attachment anchor 3108. In various embodiments, the attachment anchor 3108 may be reinforced along defined load pathways by load-distributing stitching, e.g., bar-tack stitching, so that forces applied at the central loop section 3108.6 are distributed through the textile loop and into the internal strapping arrangement 3110.

When the harness system 3100 is coupled to the robot 1, the attachment anchors 3108 are positioned at the shoulder portions 3102.6 at the upper extent of the torso 16. The attachment anchors 3108 can be affixed by lines to the overhead support system to support the weight of the robot 1. In the illustrative embodiment, the internal strapping arrangement 3110 is configured to couple the attachment anchors 3108 to the frame couplers 3104 to support the robot 1. In other embodiments, the attachment anchors 3108 and the frame couplers 3104 may be coupled individually to the textile harness 3102, where the textile harness 3102 includes one or more layers configured to distribute the load. When the harness system 3100 is coupled to the robot 1 and suspended from a tether attached to the attachment anchors 3108, at least a portion of the vertical load can rest upon and be carried by the waist couplers 3106 that are engaged with the anchor recesses 604.6.2, substantially suspending and supporting the robot 1 at the waist 604 and not at the shoulder joints, which might otherwise impede movement of the arm assemblies 5.

d. Frame Couplers

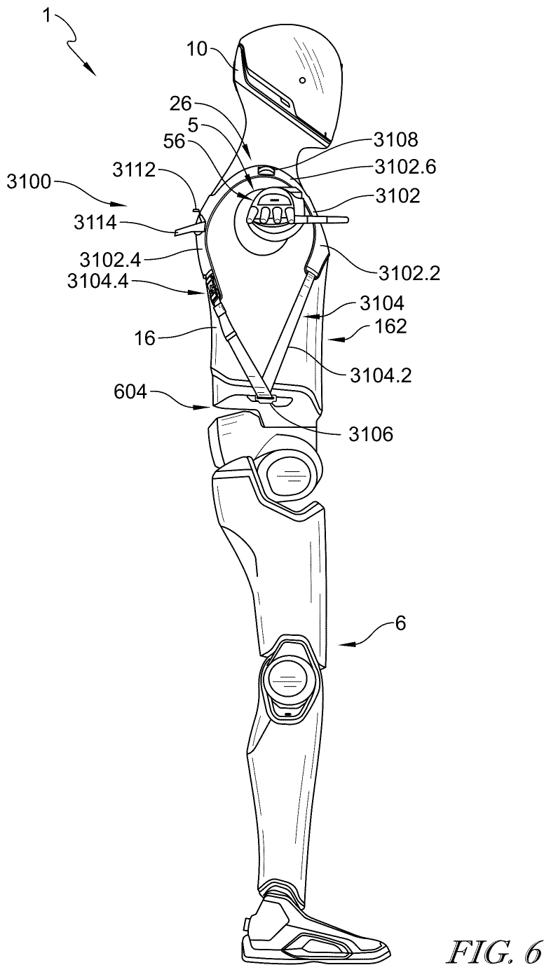

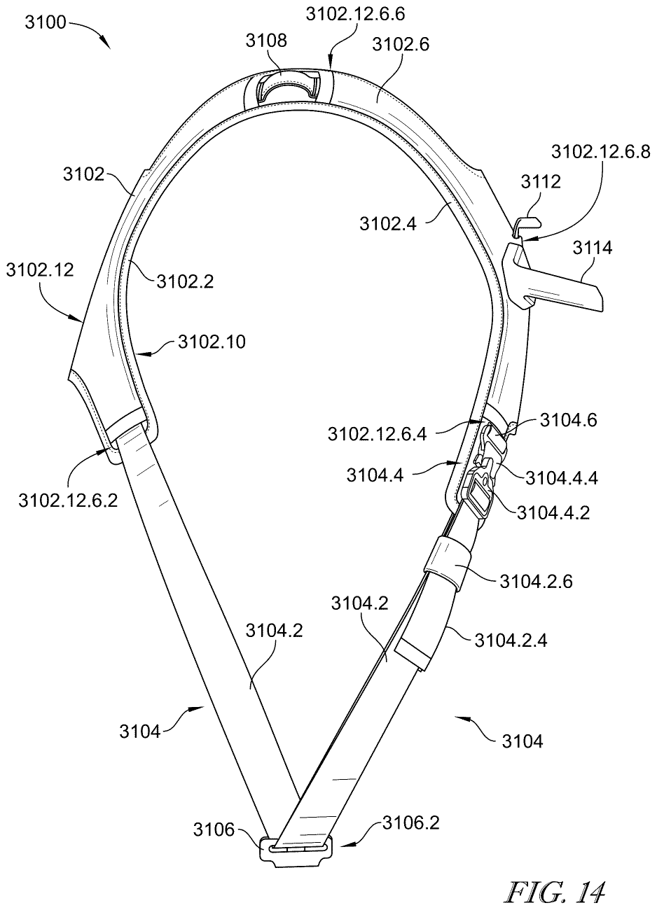

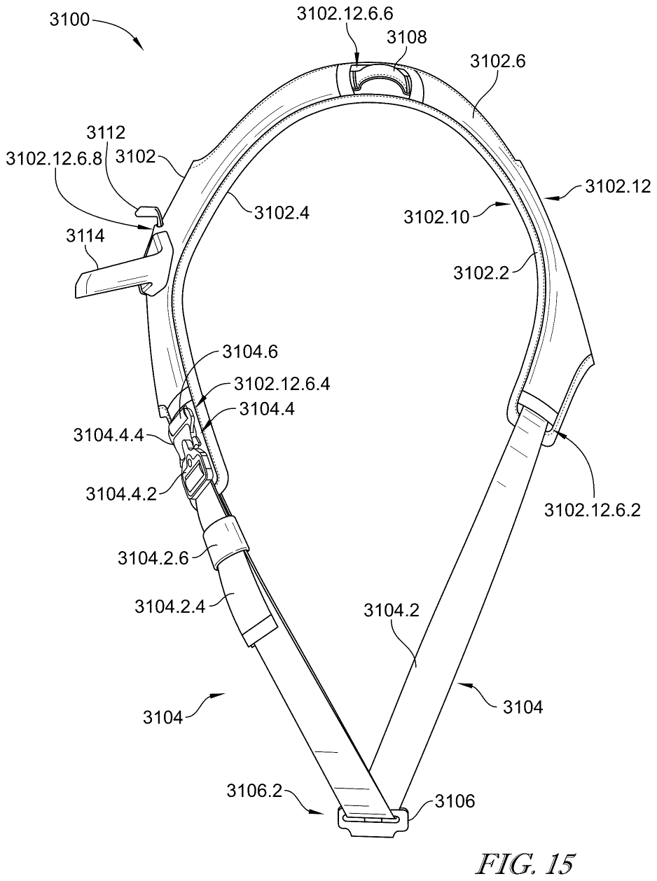

Referring to FIGS. 6-7, the harness system 3100 includes the frame couplers 3104 that extend from the textile harness 3102 and are arranged along the lateral sides of the torso 16. The frame couplers 3104 are configured to couple the harness system 3100 to the robot 1 at the waist 604. As best shown in FIGS. 14-15, each of the frame couplers 3104 includes a front harness strap 3104.2, a rear harness strap 3104.6, a buckle 3104.4 configured to couple the front and rear harness straps 3104.2, 3104.6, and a waist coupler 3106 (e.g., hook or anchor) attached to the front harness strap 3104.2. Each of the waist couplers 3106 includes a main body 3106.2 defining an aperture 3106.2.2 and an inner surface 3106.2.4, a transverse body 3106.4 defining an inner surface 3106.4.4, and an angular body 3106.6 with a projection 3106.6.2 extending therefrom. The frame couplers 3104 extend from lower extents of the chest portion 3102.2 and back portion 3102.4 of the textile harness 3102 and provide an adjustable attachment means for removably coupling the harness system 3100 to the robot 1. The frame couplers 3104 are configured to couple with the anchor recesses 604.6.2 defined in the waist 604 of the robot 1 (FIGS. 8-11). The main-body, transverse-body, and angular-body-with-projection geometry of each waist coupler 3106 is a structural coupling between the donned textile harness 3102 and the structurally reinforced concave anchor recess 604.6.2 formed in the waist 604 of the humanoid robot 1. Unlike a strap-end closure that fastens two extents of a belt or webbing to each other, the waist coupler 3106 is free of a strap-to-strap closure arrangement and is devoid of a parachute canopy release or tactical-backpack hook configuration; the waist coupler 3106 instead mates with an engineered concave waist anchor recess 604.6.2 and, through that mating, provides alignment, broad-contact load distribution, anti-slippage positioning, and positive seating that are not available from strap-end hardware alone.

i. Harness Straps

Referring to FIGS. 14-15, the front harness straps 3104.2 and the rear harness straps 3104.6 are coupled by a buckle 3104.4. In the illustrative embodiment, the front harness straps 3104.2 are significantly longer than the rear harness straps 3104.6, where the waist coupler 3106 is attached to the front harness strap 3104.2. As shown, the length of the front harness strap 3104.2 is adjustable and the length of the rear harness strap 3104.6 is fixed, where the buckle 3104.4 is positioned at the rear of the textile harness 3102 to minimize contact with the arms 5 when the robot 1 is performing a task. For example, the buckle 3104.4 may be configured as a quick-release coupler assembly and include a first buckle portion 3104.4.2 configured to mate with a second buckle portion 3104.4.4. The first buckle portion 3104.4.2 may be adjustably coupled to the front harness strap 3104.2 and the second buckle portion 3104.4.4 coupled to the rear harness strap 3104.6 that remains at a substantially fixed position. In the illustrative embodiment, each buckle 3104.4 is configured to be positioned over the left and right lower extensions 3102.4.2 of the back portion 3102.4 to minimize rubbing or scraping of the buckle 3104.4 on the surface of the robot 1 (e.g., torso cover 174).

In the illustrative embodiment, the first end portion 3104.2.2 of the front harness strap 3104.2 is coupled to the front cross body band 3110.2 of the chest portion 3102.2, where the harness strap 3104.2 passes through an aperture 3106.2.2 in the waist coupler 3106 to the first buckle portion 3104.4.2, which is arranged within the second end portion 3104.2.4 of the harness strap 3104.2. The first buckle portion 3104.4.2 receives an extent of the harness strap 3104.2 and is configured to be positioned along the harness strap 3104.2 to provide the harness system 3100 with an operator-adjustable fit to the torso 16 of the robot 1. The first buckle portion 3104.4.2 is configured to releasably couple to the second buckle portion 3104.4.4 that is affixed to the rear harness strap 3104.6 at a lower extent of the back portion 3102.4. The length of front harness strap 3104.2 may be adjusted (if needed) by pulling on the second end portion 3104.2.4. In various embodiments, the front harness strap 3104.2 may include a strap retainer 3104.2.6 that may be positioned along the front harness strap 3104.2 to hold the second end portion 3104.2.4 against another extent of the harness strap 3104.2. In other embodiments, the first end portion 3104.2.2 may be affixed to a lower extent of the chest portion 3102.2.

In the illustrative embodiment, the rear harness strap 3104.6 has a fixed length, where an extent of the rear harness strap 3104.6 retains the second buckle portion 3104.4.4. For example, a first end portion of the rear harness strap 3104.6 may be coupled to the rear cross body band 3110.4 of the back portion 3102.4, extend through an aperture of the second buckle portion 3104.4.4, and the second end portion of the rear harness strap 3104.6 is secured to an extent of the rear harness strap 3104.6 In some embodiments, the second end portion may extend to be coupled with the rear cross body band 3110.4. The second buckle portion 3104.4.4 is held in a position over the left and right lower extensions 3102.4.2 of the back portion 3102.4, such that when the first buckle portion 3104.4.2 is attached to the front harness strap 3104.2 secured, the buckle 3104.4 is positioned over the lower extensions 3102.4.2. This positions at least the base panel 3102.10 of the textile harness 3102 as a buffer to help protect the robot 1 (e.g., torso cover 174 and/or torso housing 162) from potential damage from contact with the buckle 3104.4.

Further, to prevent unintentional release or loosening of the textile harness 3102, the quick-release buckles 3104.4 (and potentially any other buckles disclosed herein) may be replaced or supplemented with locking mechanisms, which may include a secondary action to release (e.g., a sliding lock, a double-action release). In some embodiments, the buckles 3104.4 are configured with a secondary-locking, double-action release arrangement that requires more than a single motion or force to release, so that the harness straps 3104.2, 3104.6 do not inadvertently disengage under dynamic or unintended loading; in such embodiments, release of the buckle 3104.4 coordinates with the positive-locking engagement of the waist coupler 3106, so that the operator performs the multi-step release action, tension in the harness straps 3104.2, 3104.6 is relieved, and the waist coupler 3106 may then be removed from the corresponding anchor recess 604.6.2. The secondary-locking, double-action release arrangement of the buckle 3104.4 is free of a single-motion single-action release pathway, and does not require only a single press, pull, or squeeze to disengage under load. During assembly, the harness system 3100 can be donned upon the torso 16 of the robot 1 by draping the textile harness 3102 over the torso 16 such that the robot's head 10.1 passes through the neck opening 3102.8. Furthermore, mating components of the fastening system, such as the buckle 3104.4 or different sections of adjustable straps 3104.2, can be color-coded or uniquely labeled to prevent mismatches and streamline the connection process. The harness system 3100 may also incorporate AR-compatible markers or QR codes on the textile harness 3102, allowing operators to rapidly confirm proper harness alignment using augmented reality devices or mobile applications.

ii. Waist Couplers

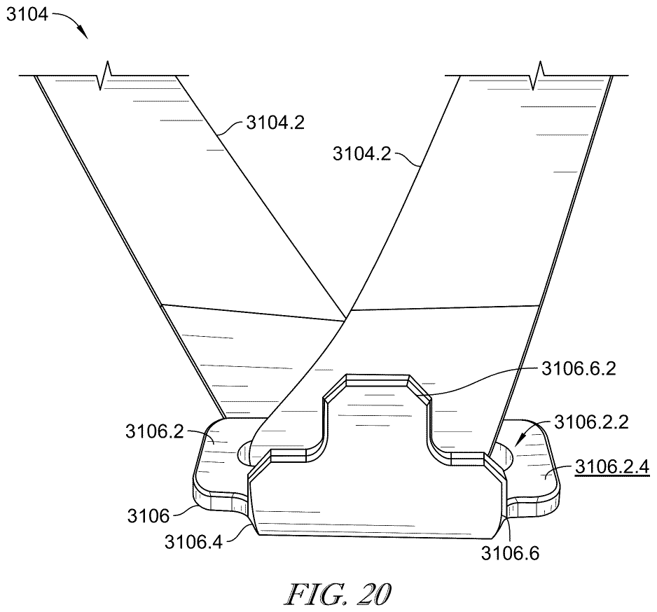

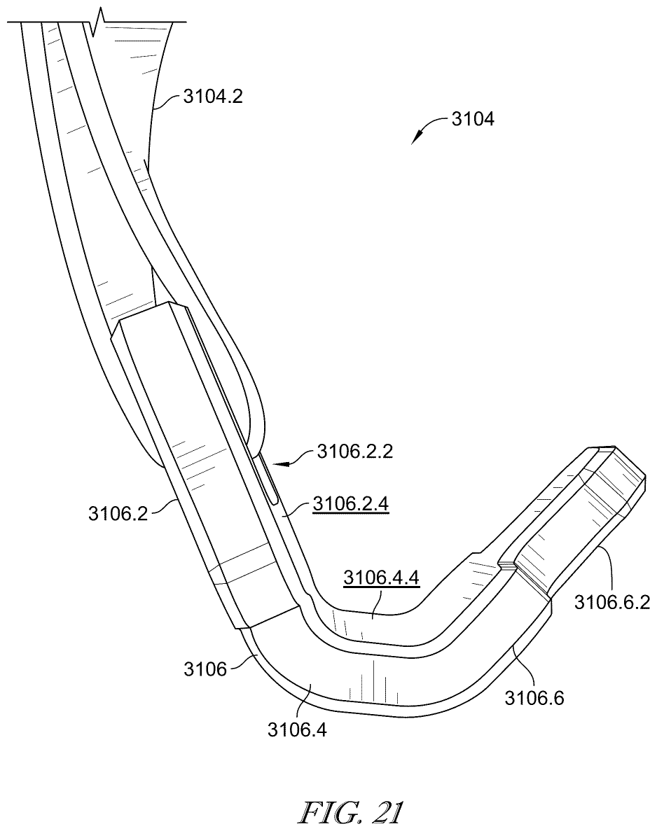

As best shown in FIGS. 8, 9, 20, and 21, the waist couplers 3106 are attached to the front harness straps 3104.2 and configured to engage with anchor apertures 604.6.4 within harness support portions 604.6 of the robot waist 604 to secure the harness system 3100 to the robot 1. Each of the waist couplers 3106 includes a main body 3106.2 defining an aperture 3106.2.2 and an inner surface 3106.2.4, a transverse body 3106.4 defining an inner surface 3106.4.4, and an angular body 3106.6 with a projection 3106.6.2 extending therefrom. The waist coupler 3106 is configured to conform in shape and to wrap partially around a lower extent of the waist body 604.2 to provide a secure fit. The waist couplers 3106 may be configured to match the contours of the waist body 604.2 adjacent to the harness supports 604.6 to minimize slippage.

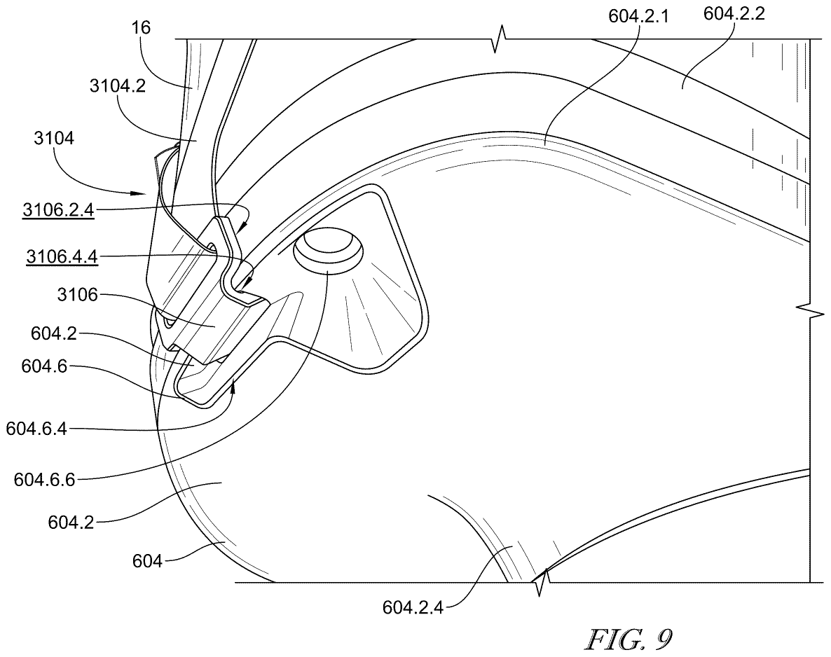

As shown in FIGS. 8-9, the waist couplers 3106 are configured to engage with the waist of the robot 1 at corresponding anchor apertures 604.6.4 of the harness supports 604.6 defined in the waist 604 of the robot 1. The waist couplers 3106 are configured such that the inner surface 3106.2.4 may be arranged adjacent to the waist rim 604.2.2, the inner surface 3106.4.4 may be arranged adjacent to the main body 604.2.1, the angular body 3106.6 may be received within the anchor recess 604.6.2, and the projection 3106.6.2 received within the anchor aperture 604.6.4 for a secure attachment. In particular, the projection 3106.6.2 received within the anchor aperture 604.6.4 also positions the angular body 3106.6 to provide a broader contact surface area to hold the waist coupler 3106 in position and aligned with the center of gravity of the torso 16 at the vertical torso plane (P₁). With the waist couplers 3106 engaged with the anchor recesses 604.6.2, the strap lengths may be adjusted to tension the textile harness 3102 and maintain engagement of the waist couplers 3106 in the harness supports 604.6. When at least a portion of the weight of the robot 1 is suspended by the harness system 3100 (at the attachment anchors 3108, the auxiliary handle 3112, and/or the rear handle 3114), the suspension forces are transferred from the textile harness 3102 (e.g., via the internal strapping arrangement 3110) to the frame couplers 3104 and the waist couplers 3106, and to the waist body 604.2 along the inner surfaces 3106.2.4 and 3106.4.4 of the couplers 3106.

To improve the security of the connection and to further protect the robot's finish, the inner surfaces 3106.2.4, 3106.4.4 of the waist coupler 3106 may be augmented in some embodiments by applying a layer of high-friction, compliant material, such as rubber, silicone, or a specialized polymer coating. This enhancement increases the frictional grip against the waist body 604.2, reducing potential slippage under load, and provides an additional cushioning layer to prevent scratching or marring of the robot's surface. In some embodiments, the waist couplers 3106 may include positive locking mechanisms. For example, the high-friction, compliant material may be silicone rubber approximately 1 mm to 3 mm thick arranged over the inner surfaces 3106.2.4, 3106.4.4, which serves the dual function of (a) increasing the frictional grip between the waist coupler 3106 and the waist body 604.2 of the robot 1 to resist slippage under dynamic load during a fall, a righting operation, or normal articulation, and (b) cushioning the coupler-to-robot interface to prevent the rigid coupler structure from scratching, denting, or marring the painted, anodized, or otherwise finished surface of the waist 604. Unlike applications of silicone or rubber on the inside of a belt or garment directed to contact with a human wearer's skin or clothing, the high-friction, compliant material arranged on the inner surfaces 3106.2.4, 3106.4.4 is not intended to engage human skin and does not require the ergonomic compliance profile of a skin-contact liner; it is instead configured to engage and preserve the finished non-biological surface of the waist body 604.2 of the humanoid robot 1.

In some embodiments, the positive locking mechanism of the waist coupler 3106 comprises a spring-loaded pin that provides a mechanically verifiable indication that the waist coupler 3106 is fully and securely engaged with the corresponding harness support 604.6. The positive locking mechanism is arranged such that complete insertion of the projection 3106.6.2 into the anchor aperture 604.6.4, together with proper seating of the angular body 3106.6 within the anchor recess 604.6.2, causes the spring-loaded pin to engage a complementary retaining feature, giving the operator a tactile and/or visual confirmation that the harness system 3100 is properly coupled to the robot 1. In alternative embodiments, the positive locking mechanism may be embodied as a detent retainer, a cam latch, a rotating pawl, a captive ball-and-socket retainer, or a magnetically assisted latch that performs the equivalent verification function. The disclosed positive locking mechanism is free of a passive friction-only retention scheme that gives no installation-verification feedback, and does not rely on strap tension alone to confirm proper seating in the anchor recess 604.6.2.

e. Handles

The harness system 3100 includes an auxiliary handle 3112 and/or a rear handle 3114 arranged on the back portion 3102.4 of the textile harness 3102. The handles 3112, 3114 may be coupled to the internal strapping arrangement 3110, such that vertical lifting loads on the rear handle 3114 and/or the auxiliary handle 3112 can be transmitted substantially directly to the frame couplers 3104. For example, when the robot 1 is lifted by one of the handles 3112, 3114, at least a portion of the vertical load can be carried by the waist couplers 3106 engaged with the anchor recesses 604.6.2, supporting the robot 1 at the waist 604 and not at the shoulder joints. In some cases, one or both of the handles 3112, 3114 may be used when the harness system 3100 is coupled to the robot 1 but not coupled to an external support system.

The auxiliary handle 3112 may be a loop of textile (e.g., a padded strap) formed with or coupled to the rear cross body band 3110.4 and/or the rear harness strap 3104.6 of the frame couplers 3104. The auxiliary handle 3112 may have a diameter that permits a human operator's hand(s) or a robot's hand(s) to reach into the loop and grip the loop. In the illustrative embodiment, the auxiliary handle 3112 is shown coupled to the rear cross body band 3110.4 of the internal strapping arrangement 3110, which ties the auxiliary handle 3112 to the frame couplers 3104 coupled to the waist 604 of the robot 1. The auxiliary handle 3112 is configured to extend through the handle opening 3102.12.6.8 formed in the cover panel 3102.12 of the textile harness 3102. Because the auxiliary handle 3112 is coupled directly to the internal strapping arrangement 3110, it may be used as an additional or alternative attachment point for an external support system.

The rear handle 3114 may be coupled to the textile harness 3102 directly or at the rear cross body band 3110.4. The rear handle 3114 may be formed from a durable rigid material (e.g., polymer or plastic) and extend away from the back portion 3102.4. For example, the rear handle 3114 may include a rigid support base plate 3114.2 and an external bar 3114.4, where the external bar 3114.4 couples through the cover panel 3102.12 to secure to the rigid support base plate 3114.2. The external bar 3114.4 is spaced away from an external surface of the textile harness 3102, where the bar has a diameter appropriate for providing a secure grip to human or robotic hands. In some embodiments, the handles can be affixed to a rigid support base plate 3114.2 layered within the back portion 3102.4 to distribute mechanical loads across a wider surface area of the textile harness 3102 or to improve force transfer. For example, the rigid support base plate 3114.2 may be positioned at or partially surround the rear cross body band 3110.4 of the internal strapping arrangement 3110. In some embodiments, both the rear handle 3114 and the auxiliary handle 3112 are affixed to a single rigid support base plate 3114.2 layered within the back portion 3102.4 and coupled to the internal strapping arrangement 3110, so that grip forces applied to either handle 3112, 3114 are distributed across a broad surface area of the textile harness 3102 and transmitted through the internal strapping arrangement 3110 into the frame couplers 3104 and waist couplers 3106. The dual rigid-and-soft handle arrangement of the rear handle 3114 and the auxiliary handle 3112 affixed to the shared rigid support base plate 3114.2 is free of a single-handle-type back panel (whether rigid-only or soft-only), and does not require a human operator to choose between a rigid grip and a compliant textile-loop grip at the expense of losing the other; the operator, or a second humanoid robot, may apply a firm rigid-bar grip (e.g., when carrying a powered-down robot 1 or rotating it upright from a rearward fall) or a compliant textile-loop grip (e.g., when the robot 1 is lying in an awkward orientation in which the external bar 3114.4 is difficult to reach), while in either case transmitting the applied force through the internal strapping arrangement 3110 into the structurally reinforced waist 604.

The rear handle 3114 may provide extra support and protection for the robot 1 when the harness system 3100 is coupled to the robot 1, but not coupled to an external support system. This may be beneficial if the robot 1 falls backward while not connected to an overhead support system, as the rear handle 3114 may help distribute forces away from an upper edge of the battery pack. For example, the rear handle 3114 may extend over a substantial width of the rear extent of the torso 16 and is spaced from the torso housing 162, such that in a rearward fall, the rear handle 3114 would likely contact the ground plane (PG) and attenuate at least a portion of the impact forces. Further, the rigid support base plate 3114.2 may also improve force transfer between the rear handle 3114 and the shoulder portions 3102.6 and/or the waist couplers 3106.

In some embodiments, the rear handle 3114 and/or the auxiliary handle 3112 can be configured to be suspended from other supports or configured to attach to an overhead tether or support system. For example, the auxiliary handle 3112, the rear handle 3114, or other mounting points can be configured to attach to an overhead tether or support system. In other embodiments, the harness system 3100 may also be configured with other types of grips or mount points (e.g., hook-and-loop fastener pads, magnets, Modular Lightweight Load-carrying Equipment (MOLLE) loops, DIN rails).

f. Harness Securement

The harness system 3100 provides attachment anchors 3108 at an uppermost extent of the torso 16 on both sides of the head 10.1 that are anchored to the waist 604 of the robot 1. This arrangement helps ensure that the harness system 3100 does not limit the robot's range of motion or damage the arms 5 or head 10.1 of the robot 1. By coupling the harness system 3100 to the robot 1 at the waist 604 and in plane with the center of gravity of the torso 16, the robot 1 may remain substantially upright when suspended by the harness 3100 at the attachment anchors 3108.

The harness system 3100 may be secured to the humanoid robot 1 by: (i) positioning the harness system 3100 on a torso 16 of the humanoid robot 1, (ii) engaging waist couplers 3106 of the frame couplers 3104 with the anchor recesses 604.6.2 defined in a waist 604 of the humanoid robot 1, and (iii) adjusting the tension in the harness straps 3104.2 of the frame couplers 3104 to maintain engagement of the waist couplers 3106 with the anchor recesses 604.6.2. The humanoid robot 1 may be coupled to an external support system via coupling a line to the attachment anchors 3108 positioned on the shoulder portions 3102.6 of the harness system 3100 on the robot 1. At least one grab handle on the back portion 3102.4 of the harness system 3100 may be provided for manual manipulation of the humanoid robot 1, wherein the at least one grab handle includes both a rear handle 3114 (e.g., a rigid grab handle) and an auxiliary handle 3112 (e.g., a soft grab handle formed as a textile loop).

As best seen in FIGS. 8-11, the harness system 3100 is arranged on the robot 1 such that the chest portion 3102.2 of the textile harness 3102 covers a front extent of the robot's torso 16 and the back portion 3102.4 of the textile harness 3102 covers a rear extent of the robot's torso 16. The waist couplers 3106 are engaged with the waist 604 of the robot 1 at corresponding anchor apertures 604.6.4 of the harness supports 604.6. The waist couplers 3106 (e.g., the main body 3106.2, the transverse body 3106.4, and the angular body 3106.6) are configured to wrap partially around a lower extent of the waist body 604.2.

As shown in FIGS. 8-9, the waist couplers 3106 are arranged such that the inner surface 3106.2.4 contacts or is adjacent to the waist rim 604.2.2, the inner surface 3106.4.4 contacts or is adjacent to the main body 604.2.1, and the angular body 3106.6 and the projection 3106.6.2 extend into the anchor recess 604.6.2 defined in the waist 604. In particular, the projection 3106.6.2 of each waist coupler 3106 is received within the anchor aperture 604.6.4 and an extent of the angular body 3106.6 is received within the anchor recess 604.6.2 for a secure attachment. With the waist couplers 3106 engaged with the anchor recesses 604.6.2, the buckles 3104.4 fastened and the strap lengths may be adjusted to tension the textile harness 3102 and maintain engagement of the waist couplers 3106 to the harness supports 604.6.

The harness supports 604.6 are formed in a structurally reinforced extent of the waist 604 and configured to support the weight of the torso 16 and upper portion of the robot 1. When at least a portion of the weight of the robot 1 is suspended by the harness system 3100 (at the attachment anchors 3108, the auxiliary handle 3112, and/or the rear handle 3114), the suspension forces are transferred from the textile harness 3102 to the harness straps 3104.2, to the waist couplers 3106, and to the waist body 604.2 along the inner surfaces 3106.2.4 and 3106.4.4.

In some embodiments, to facilitate efficient, accurate, and user-friendly installation, visual alignment markings, such as distinct lines, symbols, or color-coded patches, may be applied to both the interior surface of the textile harness 3102 and corresponding reference points on the robot's torso 16 or waist 604. These alignment markings provide clear guidance for operators to correctly position the textile harness 3102 before fastening, ensuring proper alignment of the shoulder portions 3102.6 over the upper extent of the torso 16 and positioning of the waist couplers 3106 relative to their respective anchor recesses 604.6.2.

g. Alternative Embodiments

In alternative embodiments, the harness system 3100 may be adapted for alternative embodiments and other variations detailed below. In each embodiment, the harness system remains substantially similar to the illustrative harness system 3100 and is adapted to include alternative and/or additional features. It should also be understood that the additional embodiments may be contemplated as discussed herein and said embodiments may be partially or fully combined with any of the above-described embodiments of the harness system 3100. The alternative embodiments described in the following subsections address variations of the textile harness 3102 construction, alternative attachment anchor 3108 configurations, features directed to heat dissipation at the interface between the textile harness 3102 and the torso 16, and features directed to the mounting of peripherals and routing of cabling within the harness system 3100.

i. Alternative Textile Harness Features

To ease the installation of the harness system 3100, alternative embodiments of the textile harness 3102 may include a vertical split in its front and back extents that is either centrally or asymmetrically formed to generate two halves that can be coupled to one another using any coupling means, including a heavy-duty zipper, quick-release buckles, or hook-and-loop fasteners (e.g., Velcro®), or a combination thereof. The harness system 3100 may also include openings formed in its lateral sides, extending vertically from the lower edge, potentially up to the shoulder portions 3102.6. Further embodiments might feature openings at one or both shoulder portions 3102.6, allowing the textile harness 3102 to be opened widely from the top and placed onto the robot's torso 16 without needing to pass it over the head 10.1.

Alternatively and/or additionally, the harness system 3100 may be further enhanced with a plurality of adjustment mechanisms beyond the adjustable harness straps 3104.2 and buckles 3104.4. For instance, the shoulder portions 3102.6 may incorporate length adjustment means, such as sliding buckles or hook-and-loop fasteners, allowing modification of the vertical positioning of the textile harness 3102 on the torso 16. Additionally, one or more adjustable straps may span horizontally across the chest portion 3102.2 and/or the back portion 3102.4, providing a means to modify the girth of the textile harness 3102. Such multi-point adjustability permits a more precise and secure conformation of the harness system 3100 to varying robot morphologies or when accommodating different underlayers or attached equipment.

ii. Alternative Attachment Features

In some embodiments, the attachment anchors 3108 may be configured with an integrated swivel mechanism. This swivel, potentially incorporated at the base where the attachment anchor 3108 connects to the shoulder portion 3102.6, would allow the anchor point to rotate freely (e.g., 360 degrees) relative to the textile harness 3102. Such a feature reduces strain on the tether and harness connection points and can allow for greater freedom of movement for the robot 1 without inducing problematic torque in the textile harness 3102. In some embodiments, the swivel mechanism may include a rotating collar or a bearing-supported ring coupled to the textile shell of the shoulder portion 3102.6, so that the load-bearing function of the attachment anchor 3108 is preserved while rotational freedom is provided at the interface between the tether and the textile harness 3102.

In certain embodiments, the attachment anchors 3108 may be configured with an electromagnetic quick-release mechanism for enhanced operational flexibility and safety. In such configurations, one or more electromagnets are integrated into or positioned adjacent to the attachment anchor points. Correspondingly, the mating component of the harness system 3100 would incorporate a compatible ferromagnetic element. During normal operation, the electromagnets are energized, generating a strong magnetic field that securely holds the tether's ferromagnetic component, thereby establishing a robust connection capable of supporting operational loads, including the robot's 1 weight.

However, for emergency release scenarios (such as entanglement, imminent hazard, or system malfunction requiring immediate separation) or for rapid reconfiguration or detachment needs, the electrical current supplied to the electromagnets can be intentionally interrupted. This interruption instantly collapses the magnetic field, thereby releasing the tether component from the attachment anchor 3108 with minimal delay or required physical force. The control signal to de-energize the electromagnets could be initiated manually, triggered automatically by the robot's onboard safety systems upon detection of predefined critical conditions, or activated via a remote command, offering a versatile and rapid means of detachment compared to conventional mechanical latching mechanisms.

iii. Heat Dissipation Features

Alternatively and/or additionally, the harness system 3100 may form a substantial air gap between the inner surface of the textile harness 3102 and the torso 16 or torso cover. This air gap may be formed by a compressible yet stable open structure that allows air to circulate freely within the gap, where said structure may include a 3D printed element, strategically positioned foam or rubber, or arrangements of resilient monofilament yarns. In certain embodiments, the gap can include channels that are designed to direct airflow, perhaps leveraging natural convection (e.g., inlets near the bottom edge, outlets near the top) or aligning with existing vents in the robot's torso 16 to enhance the robot's active thermal management system. In further embodiments, the open structure defining the air gap may be disposed between the cover panel 3102.12 and the base panel 3102.10 of the textile harness 3102, so that the open structure forms a ventilating interlayer within the textile harness 3102 itself without enlarging the exterior profile of the harness system 3100.

Further, the harness system 3100 may incorporate active cooling elements by including specific pockets or attachment points for receiving thermoelectric cooling modules (Peltier devices) or low-profile fans. These active elements could be powered via a power system that is integrated into the harness system 3100 and potentially controlled by the robot's thermal management system. Alternatively, the specific pockets or attachment points could include encapsulated phase-change materials (PCMs) strategically positioned over heat-prone regions to absorb excess heat during robot operation. In such embodiments, the pockets or attachment points may be formed at the interior of the textile harness 3102 adjacent to the torso 16, so that the thermoelectric cooling modules, low-profile fans, or encapsulated phase-change materials are disposed along the heat transfer path between the torso 16 and the exterior of the textile harness 3102.

In a further enhancement aimed at optimizing thermal performance, the harness system 3100 may be configured with an integrated active cooling capability directly embedded within its layered construction. This can be realized through the incorporation of a network of microfluidic channels strategically routed within one or more layers of the textile harness 3102. These channels are designed to circulate a suitable cooling liquid (e.g., water, dielectric fluid, or specialized coolant) throughout predetermined regions of the textile harness 3102, such as areas overlying known heat concentration zones on the robot's torso 16, or potentially distributed across a more substantial portion of the harness assembly for broader thermal management. In some embodiments, the microfluidic channels may be formed within the base panel 3102.10, within the cover panel 3102.12, or within an interlayer disposed therebetween, so that the channels are supported by the multi-layer textile stack and shielded from abrasion and direct contact with the robot 1 exterior.

The microfluidic cooling subsystem can be further provided with inlet and outlet ports configured to interface with an external system coupled to the overhead support system and/or the robot's 1 primary thermal management system, potentially utilizing compact pumps and heat exchangers resident on the robot 1 or integrated within the textile harness 3102 itself. In some embodiments, the inlet and outlet ports may be disposed on the back portion 3102.4 of the textile harness 3102 adjacent to the rear handle 3114 for coupling to an overhead tether, and in further embodiments the pumps and heat exchangers may be carried by the textile harness 3102 as harness-mounted peripherals. The cooling subsystem may operate in a closed-loop configuration in which the cooling liquid is recirculated through the microfluidic channels, or in an open-loop configuration in which the cooling liquid is supplied from and returned to a reservoir external to the harness system 3100.

The harness system 3100 may further include targeted enhancements applied to the harness's 3102 internal surface to help prevent scratching or marring of the robot's torso 16 finish. These enhancements may be applied to the entire internal surface or to specific regions by identifying potential high-stress zones through methods such as motion capture analysis, pressure mapping, or computational simulation of the robot performing its intended tasks. The entire inner surface or the identified specific regions could incorporate localized pockets of thicker compliant padding (e.g., gel inserts, viscoelastic foam) for improved pressure distribution and cushioning. Conversely, the entire inner surface or the specific regions could be lined with specialized low-friction materials, such as fabrics coated or woven with polytetrafluoroethylene (PTFE) or ultra-high-molecular-weight polyethylene (UHMWPE) fibers, any other known material, and/or any combination thereof.

iv. Mounting Features

In some embodiments, the harness system 3100 can be configured to support or carry additional equipment or accessories. For example, the rear handle 3114, the auxiliary handle 3112, or other mounting points can be configured to carry tools for use by the robot 1 (e.g., a form of tool belt for factory environments). In another example, the harness system 3100 can be configured to carry a backpack or other form of container or luggage, robotic peripherals, external mechanical, and/or electronic equipment. The mounting points for such equipment or accessories are integrated into the removable, donned textile harness 3102 itself, and not into the rigid structural frame or exterior housing of the robot 1, such that the peripheral-carrying configuration of the robot 1 may be reconfigured by swapping or modifying the harness system 3100 without modification of the robot 1 itself.

For example, the harness system 3100 can be configured to help the robot 1 carry hard drives or other data storage devices, specialized sensors, additional cameras, long-range communications equipment, positioning equipment (e.g., GPS), external battery, portable power generation equipment (e.g., fuel cell), cable reels/spools, winch, medical equipment, protective gear (e.g., armor, heat shielding, radiation shielding), fire suppression equipment (e.g., a fire extinguisher), parachute, floatation device, auxiliary lights, speakers, a public address system, or combinations of these and/or any other appropriate payload that can be carried by the robot 1. In further embodiments, the system 3100 may include integrated low-profile storage compartments or zippered pockets in accessible locations.

To address the need for routing wires associated with harness-mounted peripherals or robot sensors, the harness system 3100 may incorporate dedicated cable management features, such as fabric tunnels, elasticated loops sewn onto the harness surface, zippered channels running along strap edges or panels, or rigid conduits integrated within the harness layers. Such features allow for the organized and secure routing of cables, minimizing the risk of snagging on external objects, protecting cables from damage, and maintaining a cleaner, more professional appearance of the equipped robot 1. The cable management features are formed as structural parts of the removable, donned textile harness 3102 itself, and are free of integration into a rigid housing or structural frame of the robot 1; accordingly, reconfiguration of the cable routing of the harness system 3100 may be accomplished by swapping the textile harness 3102, and does not require modification of the robot 1 exterior. Unlike conventional cable-routing arrangements in which cable channels are formed in the rigid housing of a robot or are carried on accessory sleeves separate from the load-bearing suspension garment, the cable management features of the harness system 3100 cooperate with the peripheral-mounting interfaces, the frame couplers 3104, the waist couplers 3106 engaging the anchor recesses 604.6.2, and the shoulder-to-waist internal strapping arrangement 3110 within a single donned garment.

Additionally and/or alternatively, the harness system 3100 may integrate standardized interfaces for the attachment of auxiliary equipment, such as rigid polymer or metal plates with predefined mounting patterns (e.g., VESA-like patterns, grid patterns) onto the back portion 3102.4 or other suitable areas. Alternatively, standardized rail systems, such as Picatinny rails (MIL-STD-1913) or DIN rails could be affixed to or integrated within the harness structure. These standardized systems allow for the rapid, secure, and interchangeable mounting of a wide variety of off-the-shelf or custom tools, sensors, batteries, or other modules, significantly enhancing the mission adaptability of the robot 1. The standardized mechanical, electrical, and data peripheral-mounting interfaces of the harness system 3100 are carried on the removable, donned textile harness 3102 and are not integrally formed with the rigid structural body of the robot 1; such interfaces may further include sealed circular connectors rated for ingress protection (e.g., IP67) and providing selectable power rails (e.g., 5 V, 12 V, and 24 V), Picatinny rails compliant with MIL-STD-1913, and MOLLE/PALS webbing fields with quick-release hardware. Because these interfaces are carried on the textile harness 3102 rather than on the robot frame, the peripheral-mounting capability of the system 3100 can be added, removed, reconfigured, or swapped by replacing the textile harness 3102, and does not require modification of the robot 1 housing, exterior, or structural frame. Unlike conventional arrangements in which standardized payload interfaces are affixed directly to the chassis of a robot and bind the peripheral configuration to the lifetime of the platform, the disclosed harness system 3100 provides garment-level, user-configurable interchangeability of the peripheral-mounting interfaces.

### F. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/342,470, 19/357,879, 19/352,959, 19/355,393, 19/321,022, 19/355,531, 19/355,786, 19/357,879, 19/358,414, 19/362,617, 19/565,007 and 19/565,304; and (iii) U.S. Design patents application Ser. Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/705,802, 63/706,779, 63/763,209, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid-robot support system comprising: a humanoid robot comprising a torso and a waist below the torso, the waist having left and right harness supports, each harness support defining a concave anchor recess and an anchor aperture; a removable harness carried on an upper portion of the torso and having left and right upper attachment anchors; and left and right frame couplers extending from the harness to the waist; wherein each frame coupler comprises a waist coupler having a main body defining a strap aperture, a transverse body, and an angular body extending from the transverse body and carrying a projection, the projection being received in a respective anchor aperture with the angular body lying in a respective concave anchor recess, and the main body and the transverse body bearing against the waist through a compliant high-friction lining, so that load applied to the upper attachment anchors is reacted at the waist.

2. The humanoid-robot support system of claim 1, wherein the compliant high-friction lining comprises silicone rubber having a thickness between 1 mm and 3 mm and covers at least a portion of an inner surface of the main body and an inner surface of the transverse body.

3. The humanoid-robot support system of claim 1, wherein each frame coupler further comprises a spring-loaded pin carried by the angular body and biased into engagement with the respective anchor aperture when the projection is received therein, so as to positively lock the frame coupler against withdrawal from the harness support.

4. The humanoid-robot support system of claim 1, wherein each frame coupler further comprises a front harness strap passing through the strap aperture of the main body and a rear harness strap, the front and rear harness straps being joined by a quick-release buckle positioned rearward of the torso, the front harness strap being length-adjustable and the rear harness strap having a fixed length.

5. The humanoid-robot support system of claim 1, further comprising a rigid rear handle and a soft auxiliary handle both carried on a back extent of the removable harness, the rigid rear handle including a rigid support base plate layered within the harness and an external bar spaced from an exterior surface of the harness, and the soft auxiliary handle comprising a textile loop coupled to the rigid support base plate, so that lifting load applied to either the rigid rear handle or the soft auxiliary handle is transferred through the rigid support base plate to the left and right frame couplers.

6. The humanoid-robot support system of claim 1, wherein each concave anchor recess further defines a docking aperture separated from the anchor aperture, the docking aperture being sized to receive a docking arm of a support stand, and the docking aperture remaining unoccupied by the projection when the projection is received in the anchor aperture, so that the humanoid robot can be simultaneously engaged with the removable harness and a support stand.

7. The humanoid-robot support system of claim 1, wherein the removable harness comprises a chest portion, a back portion, and a pair of shoulder portions that join the chest portion to the back portion and define a neck opening therebetween, and wherein the chest portion and the back portion each comprise multiple layers including a microfiber cloth inner layer configured to contact the torso, an intermediate polyethylene foam layer having a thickness between 1.75 mm and 2.25 mm, and an outer rip-stop nylon layer having a 4-way stretch knit with a stretch between 25% and 80%.

8. A humanoid robot comprising: a head; a torso having a center of gravity, the torso defining a coronal plane; a pair of arm assemblies coupled to the torso at left and right shoulder joints; a waist coupled to a lower extent of the torso; a pair of leg assemblies extending from the waist; and a pair of harness supports formed on the waist, each harness support defining a concave anchor recess configured to receive a coupler of a removable harness, the pair of harness supports being positioned rearward of the coronal plane and laterally on opposite sides of a vertical plane containing the center of gravity of the torso.

9. The humanoid robot of claim 8, wherein each concave anchor recess further defines an anchor aperture sized to receive a projection of the coupler and a docking aperture separated from the anchor aperture and sized to receive a docking arm of a support stand.

10. The humanoid robot of claim 8, wherein each harness support defines an anchor aperture, the anchor apertures being centered about a vertical torso plane that is parallel to the coronal plane and that contains the center of gravity of the torso, so that the torso remains substantially upright when suspended at the pair of harness supports.

11. The humanoid robot of claim 8, wherein the waist comprises a waist body having a main body of shallow parabolic shape and a projecting actuator housing depending from the main body, the actuator housing receiving a spinal twist actuator that couples the torso to a pelvis, the pair of harness supports being formed in the main body on opposite sides of the actuator housing.

12. The humanoid robot of claim 8, wherein the waist further comprises at least one vent opening configured to pass cooling air into or out of an internal volume of the robot, the pair of harness supports being positioned so that the at least one vent opening remains unobstructed when the coupler of the removable harness is received in the concave anchor recess.

13. The humanoid robot of claim 8, further comprising a removable harness carried on the torso, the removable harness comprising a chest portion, a back portion, shoulder portions joining the chest portion to the back portion and defining a neck opening, and left and right frame couplers extending from lower extents of the chest portion and the back portion, each frame coupler including a waist coupler having a projection received in a respective concave anchor recess of the pair of harness supports.

14. The humanoid robot of claim 8, wherein each concave anchor recess is sized and contoured to be grasped directly by a human hand or a robotic hand, so that the pair of harness supports provides lifting points for the humanoid robot in the absence of the removable harness.

15. A humanoid robot comprising: a torso; a waist below the torso; and left and right harness supports formed on an underside of the waist, each harness support defining a concave recess with an anchor aperture and a docking aperture separated from the anchor aperture; wherein the anchor apertures are positioned rearward of a coronal plane of the robot and on opposite sides of a vertical plane that contains a center of gravity of the torso, so that engagement of a removable harness in the anchor apertures keeps the robot substantially upright while the docking apertures remain available to receive a docking arm.

16. The humanoid robot of claim 15, wherein each anchor aperture is positioned at a lateral periphery of the waist, the anchor apertures being substantially centered about the vertical plane containing the center of gravity of the torso and lying along a vertical torso plane that is parallel to the coronal plane.

17. The humanoid robot of claim 15, wherein each concave recess includes a bearing surface surrounding the anchor aperture, the bearing surface being contoured to seat an angular body of a waist coupler of the removable harness and to distribute suspension load over an area greater than an area of the anchor aperture alone.

18. The humanoid robot of claim 15, further comprising the removable harness, the removable harness including left and right frame couplers, each frame coupler including a waist coupler having a main body defining a strap aperture, a transverse body, and an angular body extending from the transverse body and carrying a projection received in a respective anchor aperture with the angular body seated in a respective concave recess.

19. The humanoid robot of claim 18, wherein each waist coupler bears against an underside of the waist through a compliant high-friction lining comprising silicone rubber having a thickness between 1 mm and 3 mm.

20. The humanoid robot of claim 15, further comprising a support stand having a docking arm sized to be received in at least one of the docking apertures, the docking arm being engageable with said at least one of the docking apertures independently of any coupler received in the anchor apertures, whereby the humanoid robot can be simultaneously supported by the removable harness at the anchor apertures and by the support stand at the docking apertures.

21. The humanoid robot of claim 15, wherein the waist further defines at least one vent opening located between the left and right harness supports, the at least one vent opening remaining unobstructed when a coupler of the removable harness is received in either anchor aperture.
